(19) United States
(12) Patent Application Publication
(10) Pub. No.: US 2012/0173160 A1
(43) Pub. Date: Jul. 5, 2012

(54) METHODS AND SYSTEMS FOR QUANTITATIVELY ASSESSING BIOLOGICAL EVENTS USING ENERGY-PAIRED SCORING

(75) Inventors: Lewis Chodosh, Philadelphia, PA (US); Zhandong Liu, Philadelphia, PA (US); Tien-Chi Pan, Campbell, CA (US)

(73) Assignee: The Trustees of the University of Pennsylvania, Philadelphia, PA (US)

(21) Appl. No.: 13/237,376

(22) Filed: Sep. 20, 2011

Related U.S. Application Data
(60) Provisional application No. 61/384,561, filed on Sep. 20, 2010.

(51) Int. Cl. G06F 19/00

(52) U.S. Cl. 702/21

(57) ABSTRACT

Methods for quantitatively assessing the status of a biological event in a testing sample comprise computing a pair-wise energy score for each analyte pair for the biological event based on a testing magnitude value and a relative correlation value for the analyte pair, computing an energy-paired score for the biological event in the testing sample by combining the pair-wise energy score for each analyte pair, and optionally computing a significance level of the energy-paired score. Systems to implement such methods comprise computer readable medium, processors, or hardware to carry out these steps. The energy-paired score provides an estimation of how likely the biological event in the testing sample is up-regulated or down-regulated, which could aid in therapy, drug discovery, prognostic evaluation, or characterization of diseases.

### CROSS-REFERENCE TO RELATED APPLICATION

This application claims the benefit of U.S. Provisional Application No. 61/384,561, filed Sep. 20, 2010, the contents of which are incorporated herein by reference in their entireties for all purposes.

### FIELD OF THE INVENTION

This invention relates generally to quantitatively assessing biological events using energy-paired scoring (EPS) (previously known as graphical random walk (GRW)). More specifically, the invention relates to using energy-paired scoring to quantitatively assess the status of a biological event in a testing sample, and related systems.

### BACKGROUND OF THE INVENTION

The ability to simultaneously measure the expression of thousands of genes using microarrays has provided important insights into basic cellular processes as well as disease states, particularly cancer. Microarray gene expression profiling has aided in diagnosis, classification, and prognosis of a broad spectrum of human cancers, and the use of gene expression assays as a clinical tool has become increasingly prevalent. The advent of molecularly targeted therapies has underscored the importance of identifying specific signaling pathways that are activated in individual cancers in order to make optimal treatment decisions. A critical first step in identifying oncology patients who are likely to benefit from a specific targeted therapy is the application of a robust assay to determine whether targetable pathways are activated in their cancer.

Direct analysis of a single protein (e.g., a targeted kinase) in a signaling cascade (e.g., BCR-ABL, EGFR or Her2 pathway), either at the genomic DNA or protein level, has been used in determining the likelihood of pathway activation. Unfortunately, this approach has several shortcomings. First, activation of signaling pathways commonly occurs at multiple nodes. As such, analysis of such a single protein in a signaling cascade may fail to recognize activation occurring elsewhere in the pathway. Thus, methods that integrate multiple potential mechanisms of activation by examining the output of a signaling pathway would be desirable. Second, as the number of available targeted therapies increases, the labor involved in individually analyzing each gene, protein, or pathway will become increasingly labor-intensive and prohibitively expensive to implement on a comprehensive scale. As such, a method that would permit simultaneous measurement of the activity of multiple signaling pathways using one tissue sample and one platform would be highly desirable.

Several computational techniques have been developed to predict activation of a signaling pathway using gene expression patterns, because altered activation of transcription factors is a common output of signaling. Gene set enrichment analysis (“GSEA”) is a computational method that determines whether a predefined set of genes exhibits statistically significant, concordant differences between two biological states. If the set of genes is enriched in one group of samples compared to the other, then that group is inferred to have activated the pathway associated with that set of genes. GSEA has several intrinsic shortcomings. First, this method requires that samples first be divided into two groups based upon prior information, such as Kras mutation status. Unfortunately, it is often not possible to divide samples in this manner. Indeed, in the above example Ras mutation may be the very alteration that the algorithm is being used to identify. Second, and equally important, as GSEA requires the comparison of two pre-defined groups, it cannot be used to estimate pathway activation in an individual sample.

Singular value decomposition (SVD)-based binary regression (“SVD regression”) is another technique that has been used to predict signaling pathway activity, particularly as a guide to the use of targeted therapies. SVD regression uses a training set in which the activity of a given signaling pathway has been specifically modulated to generate a gene expression signature. Test samples are then classified into two groups, pathway ‘on’ or pathway ‘off’, based upon their expression of that signature. As a binary classifier, SVD regression can theoretically only group samples into two classes. However, recent applications of SVD regression have treated the resulting probability score as a continuous variable reflecting the strength of pathway activity. In this manner, the probability score of two samples can be compared using standard statistical tests. While the theoretical validity of this approach has not been proven, empirically it does allow for improved sensitivity.

Unlike GSEA, SVD regression is able to predict pathway activity for individual samples and does not require a priori division of samples into two groups. However, SVD regression has several shortcomings that limit its utility. First, the theoretical underpinnings of SVD regression require that training samples be separated into two groups based upon the estimated probability that the pathway is ‘on’ or ‘off’. The pathway activities of these two groups define the maximum and minimum pathway activity that SVD regression can detect. In other words, a test sample with higher pathway activity than the positive training sample will not yield a higher predicted pathway activity. Furthermore, this binary separation limits the resolution of SVD regression as the pathway activity of samples with intermediate pathway activity is difficult to predict. Second, since SVD regression is intrinsically a linear method this technique can only capture linear dependency within the gene expression signature. As a consequence, gene-gene interactions are ignored. Third, there are many tuning parameters that are set empirically, such as the number of meta-genes. Finally, the dynamic range of the two training groups heavily influences the sensitivity and specificity of the test when applied to unknown samples.

While genome-wide analyte data provide important insights into biological events, including normal and pathological cellular states or processes, the ability to use gene expression or other data to quantitatively assess the status of biological events in a sensitive and specific manner remains an important unmet goal.

### SUMMARY OF THE INVENTION

The disclosed subject matter provides methods and systems for quantitatively assessing the status of a biological event using energy-paired scoring (EPS) (previously known as graphical random walk (GRW)).

According to one aspect of the present invention, a method for quantitatively assessing the status of a biological event in a testing sample is provided. The method comprises: (a) computing, on at least one processor, a relative testing analyte level for each of a plurality of signature analytes in the testing sample by comparing an analyte level for the each of the signature analytes in the testing sample with a corresponding analyte level in one or more testing set control samples, wherein the each of the signature analytes exhibits a change in the analyte level when the status of the biological event is altered, and wherein the biological event in the one or more testing set control samples exhibits an activity; (b) computing, on at least one processor, a pair-wise energy score for each of analyte pairs of the plurality of the signature analytes in the testing sample based on a testing magnitude value and a relative correlation value for the each of the analyte pairs in the testing sample; and (c) computing, on at least one processor, an energy-paired score for the biological event in the testing sample by combining the pair-wise energy score for the each of the analyte pairs in the testing sample. The pair-wise energy score is computed by: (i) computing the testing magnitude value for the each of the analyte pairs based on the relative testing analyte levels for the signature analytes in the each of the analyte pairs in the testing sample, (ii) computing a testing correlation value for the each of the analyte pairs based on a correlation between the relative testing analyte levels for the signature analytes in the each of the analyte pairs in the testing sample, and (iii) computing the relative correlation value for the each of the analyte pairs by comparing the testing correlation value for the each of the analyte pairs in the testing sample with a reference correlation value for the each of the analyte pairs. The method may further comprise computing a significance level of the energy-paired score.

The method may further comprise obtaining testing analyte profiles, wherein the testing analyte profiles comprise the analyte level for the each of the signature analytes in the testing sample and the corresponding analyte level in the one or more testing set control samples.

In some embodiments, the method of the present invention further comprises: (a) obtaining reference analyte profiles, wherein the reference analyte profiles comprise an analyte level for the each of the signature analytes in one or more training set reference samples and a corresponding analyte level in the one or more training set control samples, wherein the status of the biological event in the one or more training set reference samples is altered relative to a corresponding status of the biological event in the one or more training set control samples; (b) computing a relative reference analyte level for each of the signature analytes by comparing the analyte level for the each of the signature analytes in the one or more training set reference samples with the corresponding analyte level in the one or more training set control samples; and (c) computing the reference correlation value for the each of the analyte pairs based on a correlation between the relative reference expression levels for the signature genes in the each of the gene pairs in the one or more training set reference samples.

In some other embodiments, the method of the present invention further comprises selecting the plurality of the signature analytes in the testing sample. Selecting the plurality of the signature analytes may comprise selecting 50-500 signature analytes. The method may further comprise identifying the analyte pairs of the signature analytes in the testing sample.

The testing sample may be a biological sample comprising a cell, a tissue, a bodily fluid, an organism, or a combination thereof.

The biological event may be a biological action or response. The biological action may be selected from the group consisting of signal pathways, cell states, disease states, proliferation, and apoptosis. The biological response may be a response to a biological molecule, a chemical compound, a physical agent, a therapy, or a combination thereof. The chemical compound may be a toxin.

The analyte may be a biological molecule or chemical compound. It may be selected from the group consisting of an mRNA, a protein, a non-coding RNA, a metabolite, or a derivative and/or combination thereof.

The method of the present invention may further comprise treating the testing sample with an agent in an effective amount for down-regulating the biological event in the testing sample, wherein a significant positive energy-paired score is computed for the biological event in the testing sample, and wherein the agent is capable of down-regulating the biological event.

The method may also further comprise treating the testing sample with an agent in an effective amount for up-regulating the biological event in the testing sample, wherein a significant negative energy-paired score is computed for the biological event in the testing sample, and wherein the agent is capable of up-regulating the biological event.

According to another aspect of the present invention, a system for quantitatively assessing the status of a biological event in a testing sample is provided. The system comprises at least one processor, and a computer readable medium coupled to the at least one processor. The computer readable medium has instructions which when executed cause the at least one processor to: (a) compute a relative testing analyte level for each of a plurality of signature analytes in the testing sample by comparing an analyte level for the each of the signature analytes in the testing sample with a corresponding analyte level in one or more testing set control samples, wherein the each of the signature analytes exhibits a change in the analyte level when the status of the biological event is altered, and wherein the biological event in the one or more testing set control samples exhibits an activity; (b) compute a pair-wise energy score for each of analyte pairs of the plurality of the signature analytes in the testing sample based on a testing magnitude value and a relative correlation value for the each of the analyte pairs in the testing sample; and (c) compute an energy-paired score for the biological event in the testing sample by combining the pair-wise energy score for the each of the analyte pairs in the testing sample. The pair-wise energy score is computed by: (i) computing the testing magnitude value for the each of the analyte pairs based on the relative testing analyte levels for the signature analytes in the each of the analyte pairs in the testing sample, (ii) computing a testing correlation value for the each of the analyte pairs based on a correlation between the relative testing analyte levels for the signature analytes in the each of the analyte pairs in the testing sample, and (iii) computing the relative correlation value for the each of the analyte pairs by comparing the testing correlation value for the each of the analyte pairs in the testing sample with a reference correlation value for the each of the analyte pairs. In the system, the computer readable medium may have further instructions which when executed cause the at least one processor to compute a significance level of the energy-paired score.

According to yet another aspect of the present invention, a signal processing system for quantitatively assessing the status of a biological event in a testing sample is provided. The signal processing system comprises: (a) a relative testing analyte processor having an input and an output, wherein the relative testing analyte processor is configured to compute a relative testing analyte level for each of a plurality of signature analytes in the testing sample by comparing an analyte level for the each of the signature analytes in the testing sample with a corresponding analyte level in one or more testing set control samples, wherein the each of the signature analytes exhibits a change in analyte level when the status of the biological event is altered, and wherein the biological event in the one or more testing set control samples exhibits an activity; (b) a testing magnitude processor having an input and an output, wherein the input of the testing magnitude processor is connected with the output of the relative testing analyte processor, and the testing magnitude processor is configured to compute a testing magnitude value for each of analyte pairs of the plurality of the signature analytes in the testing sample based on the relative testing analyte levels for the signature analytes in the each of the analyte pairs in the testing sample; (c) a testing correlation processor having an input and an output, wherein the input of the testing correlation processor is connected with the output of the relative testing analyte processor, and the testing correlation processor is configured to compute a testing correlation value for each of the analyte pairs in the testing sample based on a correlation between the relative testing analyte levels for the signature analytes in the each of the analyte pairs in the testing sample; (d) a relative correlation processor having an input and an output, wherein the input of the relative correlation processor is connected with the output of the testing correlation processor, and the relative correlation processor is configured to compute a relative correlation value for the each of the analyte pairs in the testing sample by comparing the testing correlation value for the each of the analyte pairs in the testing sample with a reference correlation value for the each of the analyte pairs; (e) a pair-wise energy processor having an input and an output, wherein the input of the pair-wise energy processor is connected with the output of the testing magnitude processor and the output of the relative correlation processor, and the pair-wise energy processor is configured to compute a pair-wise energy score for the each of the analyte pairs in the testing sample based on the testing magnitude value and the relative correlation value for the each of the analyte pairs in the testing sample; and (f) an energy-paired score processor having an input and an output, wherein the input of the pair-wise energy processor is connected with the output of the pair-wise energy processor, and the energy-paired score processor is configured to compute an energy-paired score for the biological event in the testing sample by combining the pair-wise energy score for the each of the analyte pairs in the testing sample. The signal processing system may further comprise an energy significance processor having an input and an output, wherein the input of the energy significance processor is connected with the output of the energy-paired score processor, and the energy significance processor is configured to compute a significance level of the energy-paired score.

### BRIEF DESCRIPTION OF THE DRAWINGS

FIG. 1 is a functional diagram illustrating energy-paired scoring (EPS) approach to quantitatively assess the status of a biological event in a testing sample according to some embodiments of the disclosed subject matter.

FIG. 2 is a functional diagram illustrating energy-paired scoring (EPS) approach to quantitatively assess the status of a signaling pathway in a testing sample according to some embodiments of the disclosed subject matter.

FIG. 3 is a diagram illustrating fold-change vectors for an exemplary training sample and three exemplary testing samples (S1, S2 and S3).

FIG. 4 is a diagram for an exemplary quantitative assessment of signaling pathway status using EPS.

FIGS. 5(A)-(D) show that EPS accurately predicts pathway activation and repression in simulated datasets, whereas singular value decomposition (SVD) does not. Pathway activity was assessed using SVD (left column) and Energy-Paired Scoring (EPS) (right column) in a simulated dataset, in which the training and testing data had (A) 80% similarity in differentially expressed genes and a log-fold change variation of zero; (B) 80% similarity and a log-fold change variation between 0 and 2; (C) 50% similarity and a log-fold change variation between 0 and 2; or (D) 20% similarity and a log-fold change variation between 0 and 2. The assessment of pathway activity is shown for training set control samples, training set reference samples, testing set control samples and testing samples (+: activation group; −: repressed).

FIGS. 6(A)-(C) show that EPS sensitively and quantitatively estimates TGFβ pathway activation, whereas SVD regression does not. TGFβ pathway activation was assessed in NMuMG cells treated with TGFβ-1 using EPS or SVD regression. FIG. 6(A) shows Western blot analysis demonstrating activation of the TGFβ pathway, assessed by Smad2 phosphorylation, in testing samples. FIGS. 6(B) and 6(C) show assessment of TGFβ pathway activation in the testing samples using SVD regression and EPS, respectively.

FIGS. 7(A)-(C) show that EPS quantitatively estimates the progressive increase of TGFβ pathway activity, whereas SVD regression does not. A TGFβ signature was trained using NMuMG cells untreated or treated with 0.15 ng/ml TGFβ for 6 hours. FIG. 7(A) shows pSmad2 protein level in NMuMG cells treated with 0.5, 1.5, or 15 ng/ml TGFβ-1 (testing samples). FIGS. 7(B) and 7(C) show assessment of TGFβ pathway activity in testing samples using EPS and SVD regression, respectively.

FIGS. 8(A) and 8(B) show that EPS accurately detects signaling pathway repression, whereas SVD regression does not. FIG. 8(A) shows assessment of pathway activity in cell lines in which Myc expression was suppressed using SVD regression (dark gray), EPS (intermediate gray) and QRT-PCR (light gray). FIG. 8(B) shows the accuracy of EPS and SVD assessed by comparing the predicted decrease in Myc pathway activity to the actual extent of Myc knockdown in each cell line.

FIGS. 9(A)-(C) show that EPS detects secondary activation of endogenous signaling pathways in vivo, whereas SVD regression does not. FIG. 9(A) shows that Ras expression in a mouse mammary gland for 24 and 96 hours leads to TGFβ pathway activation, as evidenced by Smad2 phosphorylation. FIG. 9(B) shows assessment of TGFβ pathway activity using SVD regression. FIG. 9(C) shows assessment of TGFβ pathway activity using EPS.

FIGS. 10(A)-(D) show that EPS specifically detects the activation of distinct oncogenic signaling pathways in vivo, whereas SVD regression does not. FIGS. 10(A) and 10(B) show assessment of Myc pathway activity in the mammary glands of MMTV-rtTA controls (MTB) and inducible transgenic mice expressing Myc, Wnt or Neu upon induction for 0, 24, 48, or 96 hrs using EPS and SVD regression, respectively, with lighter shade indicating higher pathway activity. Three samples were tested at each time point. FIG. 10(C) shows QPCR validation of Myc pathway activity based on gene expression of Myc and its direct transcriptional targets Shmt1, Fbl, Cdk4, Hdac2, and Nol1. FIG. 10(D) shows Receiver Operating Characteristic (“ROC”) curves for SVD regression and EPS predictions.

FIGS. 11(A) and 11(B) show that EPS identifies specific chemical inhibitors of selected signaling pathways. FIG. 11(A) shows the screening results of an expression dataset comprising cells treated with 1294 small molecules to identify compounds that inhibit the Akt-mTOR pathway. LY-29004, a PI3K inhibitor, exhibited the largest repressive effect on the Akt-mTOR pathway. FIG. 11(B) shows detection of a dose-dependent decrease in the Akt-mTOR pathway activity using EPS in MCF7 cells treated with LY-294002 at 10⁻⁷ M and 10⁻⁵ M. FIG. 11(C) shows enrichment of LY-294002 at the negative portion of the score for the Akt-mTOR pathway activity using a Komolgrov-Smirnov test. Samples treated with LY-294002 were colored in black.

FIGS. 12(A) and 12(B) show that EPS identifies mouse and human cancers with Ras mutations. FIG. 12(A) shows EPS predicted Ras signaling activity based upon a Ras signature generated by comparing mouse mammary glands expressing activated Ras for 24 hrs to control glands. Using this signature, EPS correctly predicted that Myc-driven mammary tumors with Kras mutations had the highest Ras pathway activity, followed by tumors with Nras mutations and tumors with wild-type Ras. FIG. 12(B) shows that EPS predicts higher Ras pathway activity in human lung adenocarcinomas bearing Kras mutations than human lung adenocarcinomas with wild-type Ras.

FIGS. 13(A)-(C) show assessment of Myc pathway activity using EPS (A) in mouse mammary tumors driven by inducible expression of Neu, Akt, Ras, Wnt or Myc. (B) following short-term induction and de-induction of Myc in mouse pancreatic beta cells; and (C) in lymphomas with or without an IG-Myc translocation.

FIGS. 14(A)-(C) show that EPS detects accurately loss of p53 in mouse and human breast cancers. FIG. 14(A) shows assessment of p53 pathway activity using EPS in Wnt-driven mouse mammary tumors arising in a wild-type or p53^{+/-} background. Neu-driven tumors were used as a control. A subset of Wnt; p53^{+/-} tumors displayed significantly decreased activity of the p53 pathway, suggesting that these tumors had undergone loss-of-heterozygosity (LOH) indicating loss of the wild type p53 allele. FIG. 14(B) shows Southern blot analysis of genomic DNA from Wnt; p53^{+/-} tumors confirming that mouse tumor samples with low p53 pathway activity exhibited loss of the wild-type p53 allele. Tumors with a ratio of wild-type:knockout alleles below 0.6 were determined to have undergone LOH. FIG. 14(C) EPS was used to estimate p53 pathway activity in human breast cancers determined to have wild-type or mutant p53, as judged by immunohistochemistry. Tumors with mutant p53 had significantly lower p53 activity than tumors with wild-type p53.

FIGS. 15(A) and 15(B) show that elevated AKT-mTOR signature activity is highly correlated with mutations that lead to activation of the EGFR-PTEN-PI3K-Akt pathway. FIG. 15(A) shows EPS-based estimation of Akt-mTOR pathway activity in glioblastomas demonstrating that Akt-mTOR pathway activity is significantly higher in tumors with mutations in PTEN, PI3KCA, Akt, and EGFR (grey). FIG. 15(B) shows integrative analysis of the correlation between Akt-mTOR pathway activation and genetic mutations in components of the Akt pathway using EPS (upper panel: high Akt pathway activity; lower panel: low Akt pathway activity; gray: WT; black: CAN or Mutation). Tumors with mutations in at least one component of the PI3K-Akt signaling pathway had elevated Akt pathway activity compared to tumors lacking mutations.

FIGS. 16(A)-(D) show that EPS identifies Ras mutations in human lung cancer cell lines and patients. FIG. 16(A) shows Kras mutations in lung cancer cell lines identified by EPS. FIG. 16(B) shows that lung cancer cells with Kras mutations (grey) are enriched for higher pathway activity scores as compared with Kras WT (black). FIG. 16(C) shows that lung cancer patients with higher pathway activity scores are enriched for Kras mutations (grey) as compared with Kras WT (black). FIG. 16(D) shows 70% sensitivity, 86% specificity in predicting kras mutations by ROC analysis.

FIG. 17 shows EPS-predicted EMT scores in (A) human breast cancer cell lines classified as being luminal epithelial, basal epithelial, or having undergone epithelial-to-mesenchymal transition (EMT); (B) human breast tumors subdivided according to intrinsic subtype; and (C) primary and recurrent transgenic mouse mammary tumors. Circles=primary tumors; Triangles=recurrent tumors.

FIG. 18 shows EPS-predicted proliferation scores in (A) transgenic mouse mammary tumors as a function of genotype and the percentage of Ki67+cells; and (B) human breast tumors subdivided according to Ki67 quartile.

FIG. 19 shows EPS-predicted toxin exposure in C. elegans using (A) a dichlorvos-specific signature, (B) a fenamiphos-specific signature, (C) a mefloquine-specific signature, or (D) a organophosphate pesticide (OP)-specific signature. *: p<0.05; **: p<0.01; High dose=dichlorvos 50 mg/L, fenamiphos 200 mg/L, or mefloquine 500 mg/L; Mid dose=dichlorvos 15 mg/L, fenamiphos 60 mg/L, or mefloquine 250 mg/L; Low dose=dichlorvos 3 mg/L, fenamiphos 10 mg/L, or mefloquine 10 mg/L.

FIG. 20 shows EPS-predicted drug exposure in rat plasma using SELDI proteomics data.

FIG. 21 shows EPS-predicted response to Myc pathway down-regulation induced by doxycycline withdrawal in Myc-driven tumors in MMTV-rtTA/TetO-MYC (MTB/TOM) transgenic mice.

FIG. 22 shows prognostic prediction of TGF-β pathway activity in human breast cancer data sets. Survival curves for the subset of patients who had breast cancers with high predicted TGF-β pathway activity are indicated with a solid line, whereas those for patients whose breast cancers were predicted to have low TGF-β pathway activity are indicated by a dotted line.

FIG. 23 shows Prognostic prediction of MET pathway activity in human breast cancer data sets. Survival curves for the subset of patients who had breast cancers with high predicted c-MET pathway activity are indicated with a solid line, whereas those for patients whose breast cancers were predicted to have low c-MET pathway activity are indicated by a dotted line.

### DETAILED DESCRIPTION OF THE INVENTION

Embodiments of the present invention are based on the discovery of a novel computational approach, energy-paired scoring (EPS) (previously known as graphical random walk (GRW)), to assess quantitatively the status of a biological event using genomic, proteomic or metabolomic analyte data in a sensitive and specific manner analogous to the estimation of energy generated by two charged particles, as described by Coulomb's law, based on the similarity between a testing set and a training set of analyte profiles, especially fold-change in analyte levels and analyte-analyte correlation for biological event signature analytes.

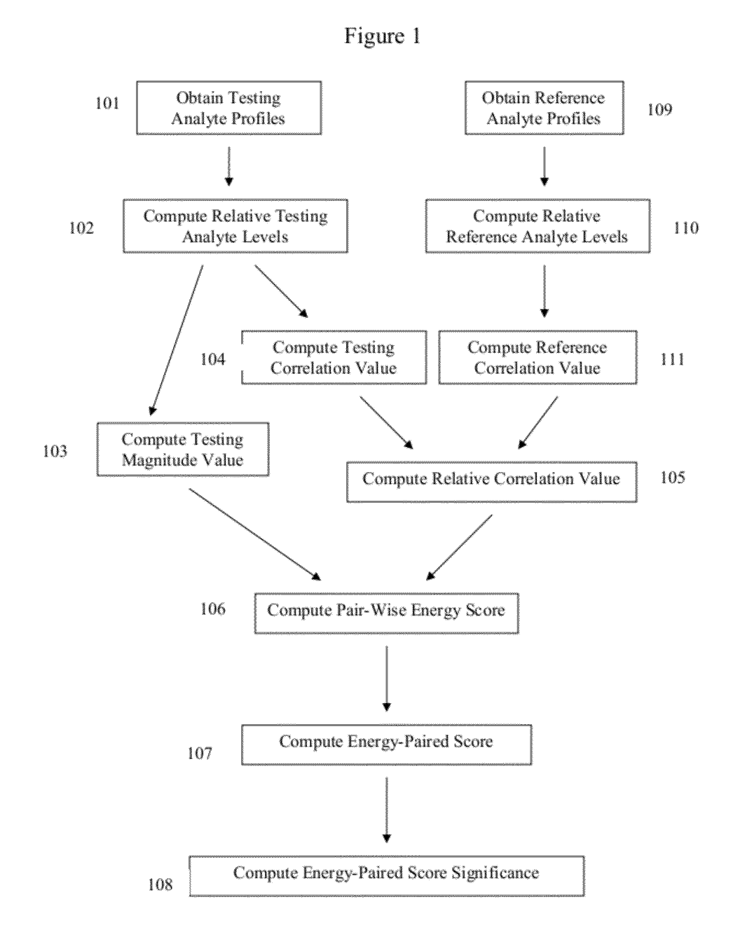

The present invention provides a method for quantitatively assessing the status of a biological event in a testing sample (FIG. 1). The method comprises (a) computing a relative testing analyte level 102 for each signature analyte in the testing sample, (b) computing a pair-wise energy score 106 for each analyte pair of the signature analytes in the testing sample, and (c) computing an energy-paired score 107 for the biological event in the testing sample by combining the pair-wise energy score 106 for each analyte pair in the testing sample. Each of the computing steps (a)-(c) is carried out on at least one processor, which may be the same or different for different computing steps. The relative testing analyte level 102 is computed by comparing an analyte level for each signature analyte in the testing sample with a corresponding analyte level in one or more testing set control samples, in which the biological event exhibits an activity. The pair-wise energy score 106 for each analyte pair in the testing sample is computed based on a testing magnitude value 103 and a relative correlation value 105 for the analyte pair by (i) computing the testing magnitude value 103 based on the relative testing analyte levels 102 for the signature analytes in the analyte pair in the testing sample, (ii) computing a testing correlation value 104 for the analyte pair based on a correlation between the relative testing analyte levels 102 for the signature analytes in the analyte pair, and (iii) computing the relative correlation value 105 for the analyte pair by comparing the testing correlation value 104 for the analyte pair in the testing sample with a reference correlation value 111 for the analyte pair.

A biological event may be any biological action or response. Examples of biological actions include signal pathway activation or repression, DNA mutation, cell states (e.g., epithelial state and mesenchymal state), disease states (e.g., diabetes, ulcerative colitis, and Alzherimer's Disease), and cellular processes such as proliferation, apoptosis, differentiation and senescence. A biological response may be a response to a biological molecule, a chemical compound, a therapy, a physical agent such as heat, ionizing radiation or ultraviolet light, a change in an environmental condition such as oxygen tension, or a combination thereof. The chemical compound may be a toxin.

A testing sample may be any sample. Preferably, the testing sample is a biological sample. The biological sample may comprise a cell, a tissue, a bodily fluid, an organism, or a combination thereof. The testing sample may be obtained from a subject.

A subject may be an organism, a microorganism, or an animal, preferably a mammal, more preferably a human. The subject may have suffered from a medical condition such as a disorder or disease. The testing sample from the subject may be affected by the medical condition.

An analyte may be any biological molecule, chemical compound, or a combination thereof. The analyte may be an mRNA, a protein, a modified form of a protein such as a phosphoprotein, a miRNA, a type of non-coding RNA other than a miRNA, a metabolite, or a derivative and/or combination thereof. A signature analyte for a biological event refers to an analyte whose level (“analyte level”) changes when the status of the biological event is altered. For example, a “signature gene” for a signaling pathway refers to a gene whose expression level changes when the status of the signaling pathway is altered. The analyte level for a signature analyte may be increased (or activated) or decreased (or inhibited) when the biological event is altered (e.g., up-regulated/activated or down-regulated/repressed). An analyte pair refers to a pair of any two signature analytes.

The method of the present invention may further comprise obtaining testing analyte profiles 101 (FIG. 1). The testing analyte profiles 101 may comprise analyte levels for the signature analytes in the testing sample and corresponding analyte levels in the testing set control samples.

Genome-wide analyte profiles for training set samples, in which the status of the biological event is known, may be used to generate training set or reference analyte profiles for selection of signature analytes for a given biological event. Training set or reference expression profiles may be generated or obtained from previously published analyte profiles and other analyte databases such as Gene Expression Omnibus, ARRAYEXPRESS, dbGAP, ONCOGMINE, Cancer Genome Atlas, Stanford Microarray Database, UNC Microarray Database, BioInvestigationIndex, NIEHS CEBS or any other repository of databases containing genomic, proteomic or metabolomic profiles.

The method of the present invention may further comprise: (a) obtaining reference analyte profiles 109, (b) computing a relative reference analyte level 110 for each signature analyte, and (c) computing the reference correlation value 111 for each analyte pair (FIG. 1). The reference analyte profiles 109 comprise analyte levels for the signature analytes in one or more training set reference samples and corresponding analyte levels in the one or more training set control samples. The status of the biological event in the training set reference samples is altered relative to a corresponding status of the biological event in the training set control samples. For example, the biological event may be off in a training set control sample, but on in a training set reference sample. The relative reference analyte level 110 for each signature analyte is computed by comparing the analyte level for the signature analyte in training set reference samples with the corresponding analyte level in training set control samples, which may be the mean analyte level of the same analyte in the training set control samples. The reference correlation value 111 for each analyte pair is computed based on a correlation between the relative reference expression levels 110 for the signature genes in the analyte pair in the training set reference samples.

The method of the present invention may further comprise selecting the plurality of the signature analytes in the testing sample. A plurality of signature analytes may be at least about 2, 3, 5, 10, 20, 50, 100, 200, 300, 400, 500 or more, preferably about 3-2000, more preferably about 50-500, signature analytes may be selected for a given biological event taking into account several factors, including the magnitude of the change in the level of the analyte in the training samples compared to reference samples (e.g., at least about 1.1, 1.2, 1.3, 1.4, 1.5, 2.0, 2.5, 5, 10, 25, 50, 100, 150, 200, 300 or 500 fold-change), the p-value associated with this change in level (e.g., no more than about 10⁻¹⁵, 10⁻¹³, 10⁻¹⁰, 10⁻⁸, 10⁻⁶, 10⁻⁵, 10⁻⁴, 0.001, 0.005, 0.01, 0.05 or 0.1), and the signal-to-noise ratio for the level of the analyte, either alone or in a combination of some or all these factors. As the p-value (or stringency) is increased, the number of signature analytes is decreased. As the fold-change cutoff is increased, the number of signature analytes is decreased.

For a given biological event, the optimal number of signature analytes selected for EPS may vary depending on the quality of the training dataset, including the analyte profiles for the training set control and reference samples, which is usually a function of the experiments used to generate the biological event signature. Positive and negative controls are generally included in determining the optimal number of signature analytes for the biological event. A biochemical assay may be included to provide positive or negative controls with respect to the status of the biological event in a testing sample for additional refinement and optimization of analyte signatures used to evaluate the status of the biological event using EPS. As described in Examples 2 and 4 below, graded increases in activation of the TGFβ pathway in some testing samples were evidenced by corresponding graded increases in Smad2 phosphorylation, which was used as a positive control.

A relative higher p-value (i.e., less stringent cutoff) is usually needed to select signature analytes from samples derived from living organisms than from samples derived from cell lines propagated in vitro because a living organism (i.e., a mouse) has more biological variables that can affect analyte levels compared to a cell line. For example, the TGFβ signature was generated from a mammary epithelial cell line, NMuMG, using a p-value of 10⁻¹⁰ without a fold-change cutoff in Example 2 as described below while a Ras signature was generated from mice using a p-value of 10⁻⁶ without a fold-change cutoff in Example 7 as described below. Adding a fold-change cutoff by, for example, about 1.1 to 500, preferably about 5 to 300, may reduce the number of signature genes to about 5-200.

Once the signature analytes are selected for a given biological event, a plurality of analyte pairs of the signature analytes may be identified. A reference correlation value for each analyte pair, or the directionality of the fold-changes of the analytes in the analyte pair, may be generated based on a correlation between the relative reference analyte levels for the signature analytes in the analyte pair, by, for example, combining the relative reference analyte levels into a 2-dimensional vector.

The method of the present invention may further comprise computing a significance level 108 of the energy-paired score 107 (FIG. 1). A significance level is the probability of obtaining absolute energy-paired score as high as the observed value by chance. The significance level may be determined by any suitable method (e.g., statistical analysis) known in the art. When a single testing sample is considered alone, its energy-paired score is considered to be significant when the aforementioned probability is small, for example, smaller than about 10%, 5%, 3%, 2%, 1%, 0.5% or 0.1%, preferably smaller than about 5%. When multiple testing samples are considered together as a group, each energy-paired score is considered to be significant when the false discovery rate (Benjamini & Hochberg) corresponding to the significance level is low, for example, smaller than about 10%, 5%, 3%, 2%, 1%, 0.5% or 0.1%, preferably less than about 5%.

Where a significant positive energy-paired score is computed for the biological event in the testing sample and an agent is capable of down-regulating the biological event, the method may further comprise treating the testing sample with the agent in an effective amount for down-regulating the biological event in the testing sample. Where a significant negative energy-paired score is computed for the biological event in the testing sample, and an agent is capable of up-regulating the biological event, the method may further comprise treating the testing sample with the agent in an effective amount for up-regulating the biological event in the testing sample. An amount of the agent is effective if sufficient to achieve a desirable result or effect (e.g., down-regulating or up-regulating a biological event) when administered to the testing sample in an appropriate dose and regimen.

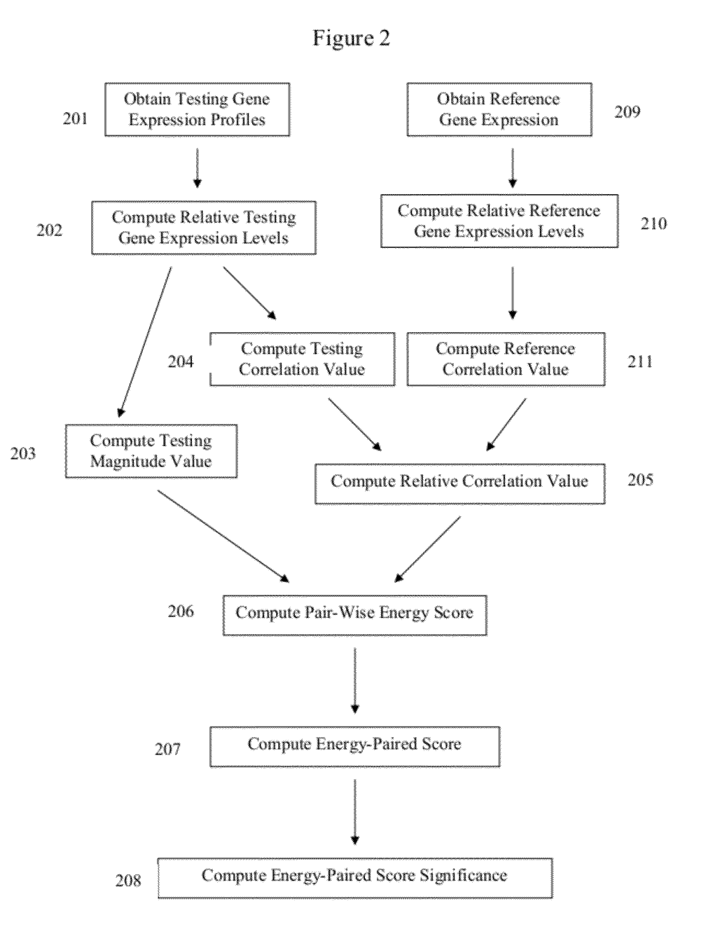

FIG. 2 is a functional diagram illustrating the energy-paired scoring (EPS) approach to quantitatively assess the status of a signaling pathway in a testing sample according to some embodiments of the present invention as explained in embodiments below. As discussed in more detail below, testing expression profiles 201 for the testing sample and a testing set control sample are used to compute relative testing expression levels 202 for the signature genes previously selected for the signaling pathway by comparing the expression level of each signature gene in the testing sample with the mean expression level of the same gene in the testing set control samples. The mean profile of the testing set control samples exhibits a level of activity for the pathway, but the pathway activity level need not to be known or ascertained. It may be the same as the training set control samples, or exhibits the same level of pathway activity as the training set control samples. It may also be an artificial sample representing a plurality of testing samples, in which the pathway activity is to be assessed, and providing a pseudo-baseline (e.g., an average of all testing samples).

Reference gene expression profiles 209 may be obtained to provide a gene expression level of each signature gene in a training set reference sample and a corresponding gene expression level in one or more training set control samples. The expression level of the signature gene in a training set reference sample may be compared with the expression level (or the mean expression level) of the same gene in the training set control samples to compute the relative reference expression level 210 for the signature gene. The status of the signaling pathway in the training set reference samples is altered relative to a corresponding status of the biological event in the training set control samples. The signaling pathway in the training set control samples may be on or off, and provides a baseline. Typically, the signaling pathway is off in a training set control sample and on in a training set reference sample. A reference correlation value 211 for each gene pair may be computed based on a correlation between the relative reference expression levels 210 for the signature genes in the gene pair in the training set reference samples.

For each gene pair, a testing magnitude value 203 is computed by comparing the relative testing expression levels 202 for the signature genes in the gene pair, while testing correlation value 204 is generated based on a correlation between the relative expression levels 202 for the signature genes in the gene pair by, for example, combining the relative expression levels 202 into a 2-dimensional vector. Then, a relative correlation value 205 is computed by comparing the testing correlation value 204 with the reference correlation value 211 for the same gene pair.

A pair-wise energy score 206 is computed based on the testing magnitude value 203 and the relative correlation value 205. The energy-paired score 207 for the signaling pathway in the testing sample is subsequently computed by combining the pair-wise energy score 206 for each gene pair. A positive pathway energy score indicates activation or up-regulation of the pathway, while a negative pathway energy score indicates repression or down-regulation of the pathway. An energy-paired score significance 208 is further computed for the energy-paired score 207.

EPS has been developed by drawing an analogy between the charge of a given particle and the magnitude of the change in expression of a given gene. Using this analogy, the similarity between two data sets is modeled on Coulomb's law, which states that the potential energy stored by a pair of charged particles is proportional to

$$\frac{{q}_{1} {q}_{2}}{r} ,$$

where q₁ and q₂ are the charges of the electric particles, and r is the distance between the two particles. Therefore, a similar formula is used to calculate the similarity between a testing set, including a test sample and one or more testing set control samples, and a training set, including one or more training set control samples and one or more training set reference samples, with respect to a given signaling pathway having a plurality of signature genes.

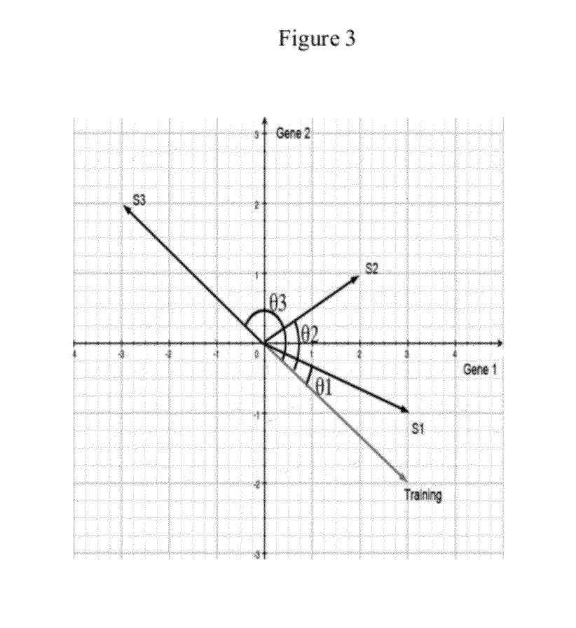

In some embodiments, as illustrated in FIGS. 2 and 3, given a pair of signature gene 1 and signature gene 2 in expression profiles (201 in FIG. 2; gene 1 and gene 2 in FIG. 3), the relative reference expression level for each signature gene is the log 2-transformed fold-change in expression between the training set reference sample and the mean expression of the training set control samples while the relative testing expression level (202 in FIG. 2) for each signature gene is the log 2-transformed fold-change in expression between the testing sample and the mean expression of the testing set control samples. In FIG. 3, the relative reference expression levels for gene 1 and gene 2 in an exemplary reference or training sample are +3 and −2, respectively, while the relative testing expression levels for gene 1 and gene 2 in exemplary sample 1 (S1) are +3 and −1, respectively. In the case where multiple training set reference samples are provided, the relative reference expression level is averaged across those reference samples. The gene pair in the training set forms a 2-dimensional training sample vector x=(x₁,x₂) (Training in FIG. 3), or the reference correlation value, where x₁ and x₂ represent the relative reference expression levels for signature genes 1 and 2, while the corresponding gene pair in the testing data forms a 2-dimensional testing sample vector y=(y₁, y₂) (S1, S2, and S3 in FIG. 3), or the testing correlation value (204 in FIG. 2), where y₁ and y₂ represent the relative testing expression levels for signature genes 1 and 2 (202 in FIG. 2). The directionality of a testing sample vector for the gene pair (S1, S2, or S3 in FIG. 3) represents a testing correlation value for the gene pair (204 in FIG. 2) while the directionality of a training sample vector for the corresponding gene pair represents a corresponding reference correlation value (211 in FIG. 2; Training in FIG. 3). The angle θ formed between vectors x and y represents the similarity between the testing sample vector (S1, S2 and S3 in FIG. 3) and the training sample vector (Training in FIG. 3) with respect to gene 1 and gene 2 (or relative testing correlation value; 205 in FIG. 2): the smaller the angle, the higher the similarity. 1/cos(θ) reflects the above similarity numerically.

The analogy between the distance, r, and 1/cos(θ) is drawn. Hence, the energy stored by a pair of genes or pair-wise energy score in a testing sample can be calculated by

$$\frac{\vert {y}_{1} {y}_{2} \vert}{1 / cos ( θ )}$$

(206 in FIG. 2). Thus, a high pair-wise energy score results from two genes whose fold-change (y₁ and y₂) is high, and whose expression relative to each other is maintained or the relative correlation value is high in the testing set (cos(θ)≈1). Conversely, an energy score of zero results from two genes whose expression is not correlated in the testing set (cos(θ)≈0). Finally, a negative energy score results from two genes whose fold-change is high and whose relative correlation is opposite (cos(θ)≈−1) in the test set as in the training set.

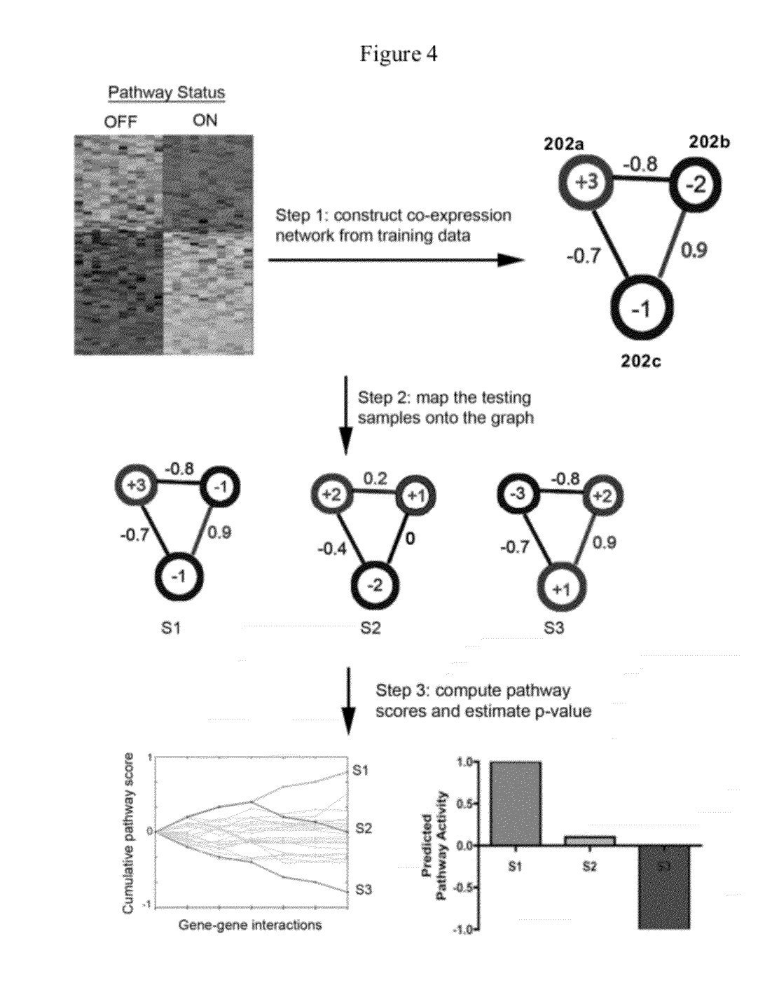

In some embodiments, genes in the expression signature form a weighted graph having circles as nodes and lines as edges (FIG. 4). Each node (e.g., 202a, 202b or 202c in FIG. 4) represents a signature gene. The value within each node represents the fold-change in log scale for the signature gene represented by the node. The weight of each edge represents correlation between the two signature genes represented by the two nodes linked by the line representing the edge. For example, relative reference expression levels, or log 2-transformed fold-changes, for 202a and 202b genes are +3 and −2, respectively, and the reference correlation value, or the weight of the edge, between these two genes is −0.8. Where training data is used to generate the weighted graph, a reference co-expression network is constructed (step 1 in FIG. 4). Testing samples are then mapped onto the weighted graph (step 2 in FIG. 4). Where testing data is used to generate the weighted graph, a testing co-expression network is constructed. For each pair of signature genes, the reference co-expression network may be compared with the testing co-expression network to compute the pair-wise energy score for the gene pair (206 in FIG. 2; step 2 in FIG. 4). The activity level of the pathway is thereby reflected in the quantitative value of the energy stored by this graph, which can be computed by taking the sum of the energy stored by all pairs of genes to achieve a cumulative pathway energy-paired score (207 in FIG. 2; step 3 in FIG. 4). The statistical significance or p-value of the pathway energy score may be computed (208 in FIG. 2; step 3 in FIG. 4).

To assess the statistical significance of the energy score in testing sets, randomly sampled gene signatures may be applied to the weighted graph constructed from training sets. Each randomly sampled signature forms a random walk on the weighted graph. The resulting pseudo-energy score is computed to estimate the distribution of the null hypothesis, which states that the energy score is the same as the energy score generated by randomly sampled signatures.

In other embodiments, given a prior selected set of signature genes for a signal pathway, EPS comprises four steps to quantitatively estimate pathway activity and assess its significance level:

Step 1: Computation of fold-change vector. The fold-change vector for each sample is computed from the log-transformed expression vector using the mean expression vector of the control group as a baseline. In the case of the training dataset (or training set), the baseline is computed from the training set control group. In cases where the control group is not clearly specified for the testing dataset, the average of all testing samples is constructed as the pseudo-baseline. To compute the relative testing expression levels for the signature genes in a sample, xᵢⱼ, the log-based expression level for genes i=1, 2, . . . p and samples j=1, 2 . . . n, is obtained or provided. Three statuses for a signaling pathway are allowed: repressed (−1), baseline (0), and activated (1). Assuming that Cₖ represent indices of the nₖ samples in one of the three pathway statuses then, for a given sample xⱼ=(x_{1,j}, . . . , x_{p,j}), the fold-change vector of sample j, fcⱼ=(fc₁ⱼ, fc₂ⱼ . . . , fcₚⱼ), is computed as

$${fc}_{ij} = {x}_{ij} - {mean}_{k ∈ {C}_{0}} ( {x}_{ik} ) .$$

This exemplifies how to compute the relative testing expression levels for the signature genes in a testing sample (e.g., 202 in FIG. 2) and the relative reference expression levels for the signature genes in a training set reference sample.

Step 2: Calculation of an Energy Score. The energy score is calculated to reflect the degree to which the changes in gene-gene interactions in a testing sample resemble the corresponding changes in the same gene-gene interactions in the training set reference samples in terms of directionality (or relative correlation value; 205 in FIG. 2) and magnitude (or testing magnitude value; 203 in FIG. 2). For each pair of gene-gene interactions, within the signature list, the pair-wise energy score is computed as described above (206 in FIG. 2). The energy score for testing sample k is defined using Coulomb's law as

$${E}_{k} = \frac{2}{n ( n - 1 )} {\sum }_{i} {\sum }_{j < i} \vert {fc}_{ik} {fc}_{jk} \vert \times cos ( t {e}_{ij}^{k} , {tr}_{ij} ) ,$$

where teᵢⱼ^{k}=(fcᵢₖ, fcⱼₖ), and tr is the center of samples in C₀ tr=( f̅c̅₁ₖ, f̅c̅₂ₖ, . . . f̅c̅ₚₖ)_{kεC}_{₀},

$$cos ( {te}_{ij}^{k} , {tr}_{ij} ) = \frac{ 〈 {te}_{ij}^{k} , {tr}_{ij} 〉}{‖ {te}_{ij}^{k} ‖ \cdot ‖ {tr}_{ij} ‖}$$

### (207 in FIG. 2).

Step 3: Estimate the significance level of the Energy Score (208 in FIG. 2). The statistical significance level (p-value) for each sample is estimated by a graphical random walk based re-sampling test. Specifically, the null hypothesis of the test is that the energy score of the testing sample for the specified pathway is not different from that obtained for a randomly sampled list of genes. Therefore, to generate the empirical null distribution, the same number of genes are randomly resampled as in the pathway signature from the genome and the energy score is recomputed. Each random sampling forms a random walk on the graph spanned by the training data set. The empirical p-value of the observed energy score is then computed relative to this null distribution.

Step 4: Estimate the significance level for the entire testing dataset. The energy span of the testing dataset is computed as the maximum energy score minus the minimum for the entire dataset. For each re-sampling in step 3, the energy span is also computed and the null distribution is constructed. Therefore, the p-value for the entire dataset is estimated empirically relative to the null distribution. The p-value for the energy span reflects the significance level of the pathway activation in the entire dataset.

The disclosed embodiments may be implemented as a method, apparatus or article of manufacture using standard programming and/or engineering techniques to produce software, firmware, hardware, or any combination thereof. Examples of articles of manufacture include hardware (e.g., integrated circuit chip, Programmable Gate Array (PGA), Application Specific Integrated Circuit (ASIC)), as well as software or programmable code embedded in a computer readable medium that is executed by at least one processor.

According to some aspects of the disclosed subject matter, a method for quantitatively assessing the status of a signaling pathway in a testing sample is provided. The method comprises (a) computing a relative testing gene expression level 202 for each signature gene in the testing sample; (b) computing a pair-wise energy score 206 for each gene pair of the signature genes based on the relative testing gene expression level 202 for the signature genes in the gene pair; and (c) computing an energy-paired score 207 for the signaling pathway in the testing sample by combining the pair-wise energy score 206 for each analyte pair in the testing sample. Each of the computing steps (a)-(c) is carried out on at least one processor, which may be the same or different for different computing steps. Optionally, a significance level 208 is computed for the energy-paired score 207.

In some embodiments, the pair-wise energy score for each gene pair is computed by comparing a reference co-expression network and a testing co-expression network for the same gene pair. The reference co-expression network may be constructed by obtaining reference data from gene expression profiles for one or more training set control samples and one or more training set reference samples; analyzing the reference data to determine a relative reference expression level for each signature gene in each gene pair; and computing the reference correlation value for each gene pair based on a correlation between the relative reference expression levels for the signature genes in each gene pair. Similarly, a testing co-expression network may be constructed by generating testing data from gene expression profiles for one or more testing set control samples and the testing sample; analyzing the testing data to determine the relative testing expression level for each signature gene in each gene pair in the testing sample; computing the testing magnitude value based on the relative testing expression level for each signature gene in each gene pair; and computing the testing correlation value based on the correlation between the relative testing expression levels for the signature genes in each gene pair.

A method for predicting the efficacy of an agent in treating a subject having a medical condition is provided where the treatment involves regulation of a biological event by the agent. The method comprises (a) computing a relative testing analyte level 102 for each signature analyte in a testing sample, which is obtained from the subject and affected by the medical condition, (b) computing a pair-wise energy score 106 for each analyte pair of the signature analytes in the testing sample, (c) computing an energy-paired score 107 for the biological event in the testing sample by combining the pair-wise energy score 106 for each analyte pair in the testing sample, and (d) computing a significance level 108 of the energy-paired score 107. Each of the computing steps (a)-(d) is carried out on at least one processor, which may be the same or different for different computing steps. The relative testing analyte level 102 is computed by comparing an analyte level for each signature analyte in the testing sample with a corresponding analyte level in one or more testing set control samples, in which the biological event exhibits an activity. The pair-wise energy score 106 for each analyte pair in the testing sample is computed based on a testing magnitude value 103 and a relative correlation value 105 for the analyte pair by (i) computing the testing magnitude value 103 based on the relative testing analyte levels 102 for the signature analytes in the analyte pair in the testing sample, (ii) computing a testing correlation value 104 for the analyte pair based on a correlation between the relative testing analyte levels 102 for the signature analytes in the analyte pair, and (iii) computing the relative correlation value 105 for the analyte pair by comparing the testing correlation value 104 for the analyte pair in the testing sample with a reference correlation value 111 for the analyte pair.

In the method for predicting the efficacy of an agent in treating a subject having a medical condition, a significant positive energy-paired score indicates high efficacy for the agent in treating the subject where the treatment involves down-regulation of the pathway by the agent, and a significant negative energy-paired score indicates high efficacy for the agent in treating the subject where the treatment involves up-regulation of the pathway by the agent. The agent may be selected from the group consisting of a biological molecule, a chemical compound, a physical agent, or a combination thereof.

The method may further comprise treating the subject with the agent in an effective amount for regulating, up-regulating or down-regulating, the biological event in the subject, wherein a high efficacy is indicated for the agent. The term “effective amount” means an amount of an agent sufficient to achieve a desirable result or effect when administered to the subject in an appropriate dose and regimen.

An agent may be any molecule, biological (e.g., protein and nucleic acid) or chemical, or a physical agent (e.g. ionizing radiation, ultraviolet light and oxygen, or a combination of two or more molecules or physical agents. The agent may be capable of producing a biological effect. A therapeutic agent is an agent that is capable of producing a therapeutic effect. A therapeutic effect is an effect relating to treatment of a disease or disorder.

A method for predicting the efficacy of an agent in treating a subject having a medical condition is provided where the treatment involves regulation of a biological event by the agent.

A method for screening for an agent that regulates a biological event in a testing sample is provided. The method comprises (a) computing a relative testing analyte level 102 for each signature analyte in the testing sample treated with the agent, (b) computing a pair-wise energy score 106 for each analyte pair of the signature analytes in the testing sample, (c) computing an energy-paired score 107 for the biological event in the testing sample by combining the pair-wise energy score 106 for each analyte pair in the testing sample, and (d) computing a significance level 108 of the energy-paired score 107. Each of the computing steps (a)-(d) is carried out on at least one processor, which may be the same or different for different computing steps. The relative testing analyte level 102 is computed by comparing an analyte level for each signature analyte in the testing sample with a corresponding analyte level in one or more testing set control samples, in which the biological event exhibits an activity. The pair-wise energy score 106 for each analyte pair in the testing sample is computed based on a testing magnitude value 103 and a relative correlation value 105 for the analyte pair by (i) computing the testing magnitude value 103 based on the relative testing analyte levels 102 for the signature analytes in the analyte pair in the testing sample, (ii) computing a testing correlation value 104 for the analyte pair based on a correlation between the relative testing analyte levels 102 for the signature analytes in the analyte pair, and (iii) computing the relative correlation value 105 for the analyte pair by comparing the testing correlation value 104 for the analyte pair in the testing sample with a reference correlation value 111 for the analyte pair.

In the method for screening for an agent that regulates a biological event in a testing sample, a significant positive energy-paired score indicates that the agent up-regulates or activates the biological event in the testing sample, and a significant negative energy-paired score indicates that the agent down-regulates the biological event in the testing sample.

The concentration of the agent used to treat the testing sample may be adjusted to identify optimal concentration of the agent in regulating the biological event based on the resulting energy-paired score and the significance of the energy score.

One or more steps of the methods according to the present invention may be implemented or performed on one or more processors.

The methods according to the present invention may be used to screen for a biological event (e.g., signaling pathway) whose alteration is associated with a medical condition (e.g., disease or disorder) by assessing the energy-paired score for a testing sample relevant to the medical condition with signature genes for different signaling pathways. A significant positive or negative energy-paired score for a biological event indicates that the alteration of the pathway is associated with the medical condition. An association between alteration of a specific biological event with an individual tumor may provide a tumor specific treatment by targeting the specific biological event.

The methods may be also used to assess the status of a medical condition (e.g., disease or disorder) in a patient where an alteration to a biological event (e.g., a signaling pathway) is associated of the medical condition in the patient, by monitoring the status of the biological event in a testing sample, which is obtained from the patient and affected by the medical condition. In assessing energy-paired score, a relevant sample obtained from the patient at an earlier time point may be used as a testing set control sample. For example, if inhibition or repression of a biological event is associated with a medical condition, a positive energy-paired score indicates an improvement of the medical condition in the patient.

Similarly, the methods may be used to assess the effectiveness of a treatment in a patient where the treatment involves regulation of a biological event (e.g., a signaling pathway) by monitoring the status of the biological event in an affected testing sample from the patient. In assessing the energy-paired score, a relevant sample from the patient before or at an earlier stage of the treatment may be used a testing set control sample. For example, if the treatment involves up-regulation or activation of a biological event, a positive energy score indicates that the treatment is effective in the patient.

For each of the methods according to the present invention, a system is provided. The system comprises one or multiple processors and a computer readable medium coupled to the processors, having instructions which when executed cause the at least one processor to carry out the computing steps in each of the methods according to the present invention. Multiple processors may work in parallel. The computer readable medium may include data such as signature analyte for a biological event, analyte pairs of the signature analytes, an analyte profile for a testing sample, an analyte profile for a testing set control sample, and a reference correlation value for an analyte pair. The computer readable medium may also include programs for computing a relative testing analyte level for a signature analyte, a testing magnitude value for an analyte pair, a testing correlation value for an analyte pair, a relative correlation value for a analyte pair, a pair-wise energy score for a analyte pair, an energy-paired score for a biological event in a testing sample, and a significance level for an energy-paired score. The system leads to a quantitative assessment of the status of the biological event in the testing sample for various purposes.

A system for quantitatively assessing the status of a biological event in a testing sample comprises: at least one processor, and a computer readable medium coupled to the at least one processor, having instructions which when executed cause the at least one processor to: (a) compute a relative testing analyte level 102 for each signature analyte in the testing sample, (b) compute a pair-wise energy score 106 for each analyte pair of the signature analytes in the testing sample, and (c) compute an energy-paired score 107 for the biological event in the testing sample by combining the pair-wise energy score 106 for each analyte pair in the testing sample. Each of the computing steps (a)-(c) is carried out on at least one processor, which may be the same or different for different computing steps. The relative testing analyte level 102 is computed by comparing an analyte level for each signature analyte in the testing sample with a corresponding analyte level in one or more testing set control samples, in which the biological event exhibits an activity. The pair-wise energy score 106 for each analyte pair in the testing sample is computed based on a testing magnitude value 103 and a relative correlation value 105 for the analyte pair by (i) computing the testing magnitude value 103 based on the relative testing analyte levels 102 for the signature analytes in the analyte pair in the testing sample, (ii) computing a testing correlation value 104 for the analyte pair based on a correlation between the relative testing analyte levels 102 for the signature analytes in the analyte pair, and (iii) computing the relative correlation value 105 for the analyte pair by comparing the testing correlation value 104 for the analyte pair in the testing sample with a reference correlation value 111 for the analyte pair.

In some embodiments, the computer readable medium may have further instructions which when executed cause the at least one processor to compute a significance level 108 of the energy-paired score 107.

A system for predicting the efficacy of an agent in treating a subject having a medical condition, wherein the treatment involves regulation of a biological event by the agent, comprises: at least one processor, and a computer readable medium coupled to the at least one processor, having instructions which when executed cause the at least one processor to: (a) compute a relative testing analyte level 102 for each signature analyte in the testing sample, (b) compute a pair-wise energy score 106 for each analyte pair of the signature analytes in the testing sample, (c) compute an energy-paired score 107 for the biological event in the testing sample by combining the pair-wise energy score 106 for each analyte pair in the testing sample, and (d) compute a significance level 108 of the energy-paired score 107. Each of the computing steps (a)-(d) is carried out on at least one processor, which may be the same or different for different computing steps. The relative testing analyte level 102 is computed by comparing an analyte level for each signature analyte in the testing sample with a corresponding analyte level in one or more testing set control samples, in which the biological event exhibits an activity. The pair-wise energy score 106 for each analyte pair in the testing sample is computed based on a testing magnitude value 103 and a relative correlation value 105 for the analyte pair by (i) computing the testing magnitude value 103 based on the relative testing analyte levels 102 for the signature analytes in the analyte pair in the testing sample, (ii) computing a testing correlation value 104 for the analyte pair based on a correlation between the relative testing analyte levels 102 for the signature analytes in the analyte pair, and (iii) computing the relative correlation value 105 for the analyte pair by comparing the testing correlation value 104 for the analyte pair in the testing sample with a reference correlation value 111 for the analyte pair. A significant positive energy-paired score indicates high efficacy for the agent in treating the subject where the treatment involves down-regulation of the pathway by the agent. A significant negative energy-paired score indicates high efficacy for the agent in treating the subject where the treatment involves up-regulation of the pathway by the agent

A system for screening for an agent that regulates a biological event in a testing sample, wherein the testing sample is treated with the agent, comprises: at least one processor, and a computer readable medium coupled to the at least one processor, having instructions which when executed cause the at least one processor to: (a) compute a relative testing analyte level 102 for each signature analyte in the testing sample, (b) compute a pair-wise energy score 106 for each analyte pair of the signature analytes in the testing sample, (c) compute an energy-paired score 107 for the biological event in the testing sample by combining the pair-wise energy score 106 for each analyte pair in the testing sample, and (d) compute a significance level 108 of the energy-paired score 107. Each of the computing steps (a)-(d) is carried out on at least one processor, which may be the same or different for different computing steps. The relative testing analyte level 102 is computed by comparing an analyte level for each signature analyte in the testing sample with a corresponding analyte level in one or more testing set control samples, in which the biological event exhibits an activity. The pair-wise energy score 106 for each analyte pair in the testing sample is computed based on a testing magnitude value 103 and a relative correlation value 105 for the analyte pair by (i) computing the testing magnitude value 103 based on the relative testing analyte levels 102 for the signature analytes in the analyte pair in the testing sample, (ii) computing a testing correlation value 104 for the analyte pair based on a correlation between the relative testing analyte levels 102 for the signature analytes in the analyte pair, and (iii) computing the relative correlation value 105 for the analyte pair by comparing the testing correlation value 104 for the analyte pair in the testing sample with a reference correlation value 111 for the analyte pair. A significant positive energy-paired score indicates that the agent up-regulates the biological event in the testing sample. A significant negative energy-paired score indicates that the agent down-regulates the biological event in the testing sample.

For each of the systems according to the present invention, the computer readable medium may have further instructions which when executed cause the processor to select the signature analytes for the biological event. The computer readable medium may also have further instructions which when executed cause the processor to identify the analyte pairs of the signature analytes.

For each of the systems according to the present invention, a signal processing system is provided. For example, a signal processing system for quantitatively assessing the status of a biological event in a testing sample is provided. It may comprise one or more processors to implement the functional steps as illustrated in FIG. 1. Also, one processor may be used to implement one or more functional steps as illustrated in FIG. 1. The signal processing system may comprise: (a) a relative testing analyte processor having an input and an output, wherein the relative testing analyte processor is configured to compute a relative testing analyte level 102 for each of a plurality of signature analytes in the testing sample by comparing an analyte level for the each of the signature analytes in the testing sample with a corresponding analyte level in one or more testing set control samples, wherein the each of the signature analytes exhibits a change in analyte level when the status of the biological event is altered, and wherein the biological event in the one or more testing set control samples exhibits an activity; (b) a testing magnitude processor having an input and an output, wherein the input of the testing magnitude processor is connected with the output of the relative testing analyte processor, and the testing magnitude processor is configured to compute a testing magnitude value 103 for each of analyte pairs of the plurality of the signature analytes in the testing sample based on the relative testing analyte levels 102 for the signature analytes in the each of the analyte pairs in the testing sample; (c) a testing correlation processor having an input and an output, wherein the input of the testing correlation processor is connected with the output of the relative testing analyte processor, and the testing correlation processor is configured to compute a testing correlation value 104 for each of the analyte pairs in the testing sample based on a correlation between the relative testing analyte levels 102 for the signature analytes in the each of the analyte pairs in the testing sample; (d) a relative correlation processor having an input and an output, wherein the input of the relative correlation processor is connected with the output of the testing correlation processor, and the relative correlation processor is configured to compute a relative correlation value 105 for the each of the analyte pairs in the testing sample by comparing the testing correlation value 102 for the each of the analyte pairs in the testing sample with a reference correlation value 111 for the each of the analyte pairs; (e) a pair-wise energy processor having an input and an output, wherein the input of the pair-wise energy processor is connected with the output of the testing magnitude processor and the output of the relative correlation processor, and the pair-wise energy processor is configured to compute a pair-wise energy score 106 for the each of the analyte pairs in the testing sample based on the testing magnitude value 103 and the relative correlation value 105 for the each of the analyte pairs in the testing sample; and (f) an energy-paired score processor having an input and an output, wherein the input of the pair-wise energy processor is connected with the output of the pair-wise energy processor, and the energy-paired score processor is configured to compute an energy-paired score 107 for the biological event in the testing sample by combining the pair-wise energy score 106 for the each of the analyte pairs in the testing sample.

In one embodiment, the signal processing system may further comprise an energy significance processor having an input and an output, wherein the input of the energy significance processor is connected with the output of the energy-paired score processor, and the energy significance processor is configured to compute a significance level 108 of the energy-paired score 107.

In another embodiment, the signal processing system further comprises a testing analyte profile processor having an input and an output, wherein the output of the testing analyte profile processor is connected with the input of the relative testing analyte processor, and the testing analyte profile processor is configured to provide analyte profiles for the testing sample and the one or more testing set control samples 101.

The signal processing system may be used for predicting the efficacy of an agent in treating a subject having a medical condition, wherein the treatment involves regulation of a biological event by the agent. A testing sample from the subject and affected by the medical condition may be used for computing the energy-paired score for the biological event in the testing sample, and the significance level of the energy-paired score. Where the treatment involves down-regulation or inhibition of the biological event by the therapeutic agent, a significant positive energy-paired score predicts high efficacy for the agent in treating the subject. Where the treatment involves up-regulation or activation of the biological event by the agent, a significant negative pathway score predicts high efficacy for the agent in treating the subject.

The signal processing system may also be used for screening for an agent that regulates a biological event in a testing sample, wherein the testing sample is treated with the agent. A significant positive pathway energy score indicates that the agent up-regulates or activates the biological event in the testing sample while a significant negative pathway energy score indicates that the agent down-regulates or inhibits the biological event in the testing sample.

According to the present invention, more than one training set reference samples, training set control samples, or testing set control samples may be used for EPS. When multiple samples are used, an artificial or pseudo-expression level of a given signature gene may be generated to represent corresponding expression levels in the multiple samples. For example, an average of the analyte levels of a signature analyte in multiple samples may be used for computation in EPS.

The training set samples and testing set samples may be from different organisms, or different types of cells or tissues. The expression profiles for the training set samples and the testing set samples may be obtained from different sources (e.g., high throughput platforms and array platforms). While the expression profiles used herein are gene expression profiles, other types of datasets may be used with the present invention. Examples of such datasets include proteomics data sets, phosphoproteomic data sets, metabolomics data sets, RNA sequencing data sets, antibody array data sets, microRNA array data sets, or similar data sets. The expression profiles may be generated either on an array platform, or by other quantitative measurements, such as QRT-PCR to determine the RNA expression level for a number of genes or microRNAs of interest, and sequencing to determine the copy number for a particular mRNA or microRNA. The application of EPS is not limited to data generated on an array platform. Rather, EPS is useful for datasets containing a number of analytes (i.e., proteins, metabolites, etc.), each of which is measured quantitatively as a continuous variable.

The term “about” as used herein when referring to a measurable value such as an amount, a percentage, and the like, is meant to encompass variations of ±20% or ±10%, more preferably ±5%, even more preferably ±1%, and still more preferably ±0.1% from the specified value, as such variations are appropriate.

The following examples are provided to describe exemplary aspects of the invention in greater detail. They are intended to illustrate, not to limit, the invention.

### Example 1

### EPS Accurately Predicts Pathway Activation and Repression in Simulated Datasets

The ability of EPS to predict pathway activity was tested in simulated datasets. The simulated training set contained 300 differentially expressed genes, with 5 samples in the baseline group and 5 samples in the activation group. Testing datasets were composed of three groups: baseline, activation, and repression. The testing dataset contained 300 genes, with 10 samples each in the repression, baseline, and activation groups. Two parameters were varied in order to generate testing datasets that would resemble training datasets, but with lower pathway activity as exhibited by lower similarity and higher fold-change variation. Similarity refers to the percentage of genes differentially expressed in the training dataset that were also differentially expressed in the testing datasets. For example, a similarity of 80% between testing and training data sets indicates that 80% of the 300 differentially expressed genes from the training set were also differentially expressed in the testing dataset. Fold-change variation refers to a randomized term reflecting noise that is added to the biological fold-change in expression of a gene in the testing dataset compared to the training dataset. For example, a fold-change variation of 2 indicates that a random value sampled from the uniform distribution between 0 and 2 will be added to the log-fold change of a gene in the testing dataset. The extent of similarity in the fold-change in expression for a given gene under similar conditions in different experiment has been estimated to range from 5% to 70%. By adding these terms, the simulation study would more accurately reflect experimental data that would be generated from a typical microarray experiment.

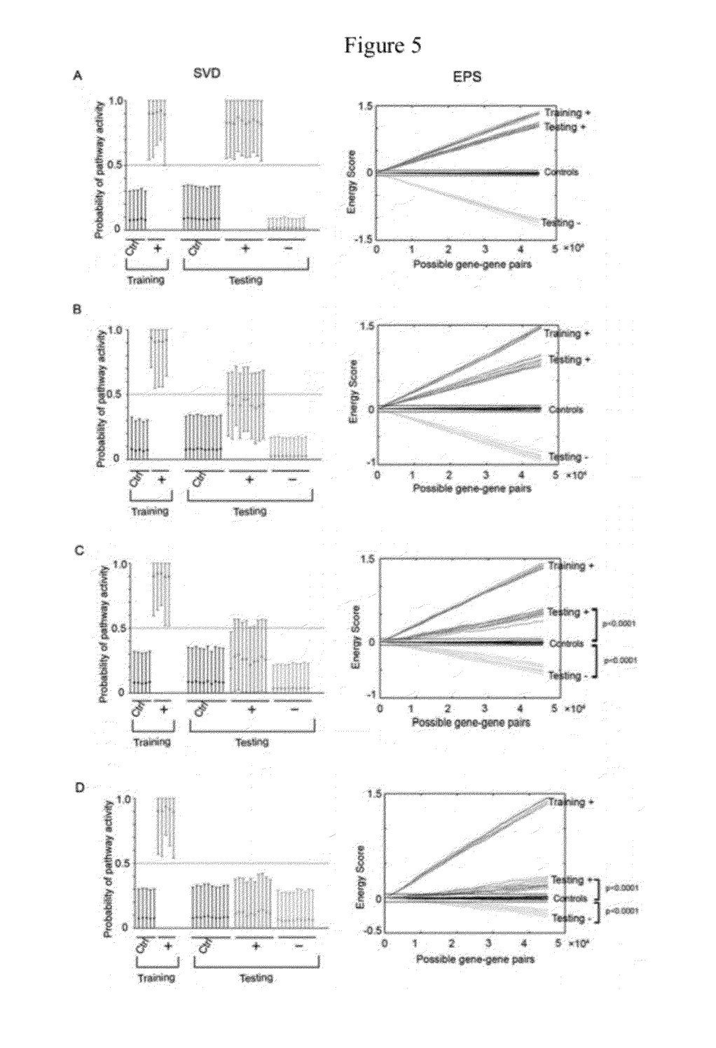

The ability of SVD regression and EPS to estimate pathway activity for testing samples that are closely related to training samples was evaluated. To achieve this, a dataset was simulated to contain the training and testing samples having 80% similarity and a fold-change variation of zero (FIG. 5A). That is, 80% of the differentially expressed genes in the training dataset were also differentially expressed in the testing samples, and their fold-change was identical to that in the training set. When SVD and EPS were tested on this dataset, both accurately predicted increased pathway activity in the activation group (FIG. 5A). However, only EPS correctly predicted decreased pathway activity in the repression group.

To investigate how both approaches perform when the fold-change varies between training and testing samples, a simulated dataset with 80% similarity and log-fold change range of 2 was generated (FIG. 5B). SVD predicted a modest increase in pathway activity for the activation group, though the probability score was below the decision boundary (0.5) indicating that SVD predicted that those samples lacked pathway activation. In contrast, EPS predicted that the activation group had strong pathway activity, with energy scores that were significantly higher (p<0.0001) than scores obtained by random permutation.

The impact of decreasing similarity on the performance of SVD and EPS was determined. Two simulated datasets were generated with either 50% or 20% similarity and fold-change variation of 2 (FIGS. 5C and 5D). For training and testing datasets with either 50% or 20% similarity, the probability of pathway activity predicted by SVD for the activation group was below the decision boundary and was not significantly different than the pathway activity of the baseline group (FIGS. 5C and 5D). In contrast, EPS detected pathway energy scores in the activation group that were significantly higher (p<0.0001) than those of the control group for both the 50% and 20% similarity datasets.

Notably, when SVD was used to predict pathway activity for repression groups it was unable to distinguish any of these groups from baseline, regardless of similarity or fold-change parameters (FIG. 5A-D). In contrast EPS predicted significantly decreased pathway energy scores for the repression group compared to baseline in all four simulated datasets.

Taken together, EPS provides pathway energy scores, and these results suggest that EPS is a more sensitive predictor of pathway activation than SVD, as evidenced by its ability to detect activation in datasets simulated to have lower pathway activity, as reflected by decreased similarity and increased fold-change range between the testing and training groups. EPS was also able to accurately detect reduced pathway activity in the repression group, whereas SVD was unable to distinguish this group from baseline in any instance.

This example illustrates a method for quantitatively assessing activation and repression of a signaling pathway in a simulated testing sample by computing pair-wise energy score and pathway energy score.

### Example 2

### EPS Sensitively and Quantitatively Estimates TGFβ Pathway Activation

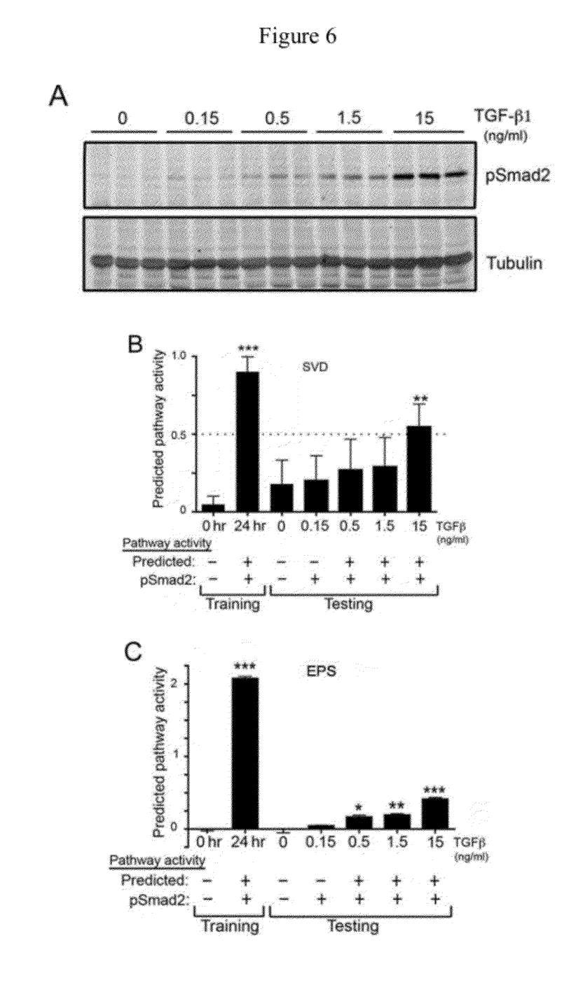

To determine whether EPS could quantitatively estimate signal pathway activity in a biological data set, a genome-wide expression data set was generated to reflect graded increases in TGFβ pathway activation by treating the mammary epithelial cell line, NMuMG, with increasing dosages of TGF-β1 for 6 hours. Signature genes were selected using a p-value of 10⁻¹⁰ associated with the changes in expression without fold-change cutoff. This led to a dose-dependent increase in TGFβ pathway activity in NMuMG cells treated with 0.15, 0.5, 1.5 or 15 ng/ml TGF-β1 as reflected biochemically by increasing levels of phosphorylated Smad2 (FIG. 6A).

To determine whether EPS could quantitatively estimate dose-dependent increases in TGFβ pathway activity using gene expression data, EPS prediction was compared to biochemical analysis of phospho-Smad2 levels in the same samples. Using a previously published TGFβ signature generated from NMuMG cells treated with TGF-β1 for 24 hours, it was determined whether SVD or EPS could detect pathway activation in NMuMG cells treated with increasing doses of TGF-β1. SVD detected pathway activation only in samples treated with the highest dose of TGFβ (15 ng/ml; FIG. 6B). Since elevated phospho-Smad2 was detected at all doses of TGF-β1, SVD had a prediction accuracy of 25%. In contrast, EPS predicted significantly increased pathway activation in samples treated with 0.5, 1.5, and 15 ng/ml of TGF-β1, and therefore achieved a prediction accuracy of 75% (FIG. 6C). This suggests that EPS can provide a quantitative estimate of pathway activity.

As expected from increasing TGFβ effects on mRNA levels over time, EPS predicted higher pathway activity in training set samples treated with TGF-β1 for 24 hours than in test samples treated with TGF-β1 for 6 hours. Given that the transcriptional changes induced by treating NMuMG cells with 5 ng/ml TGF-β1 for 24 hours were substantially larger than those observed in cells treated with comparable doses for 6 hours, the possibility that selecting a data set with lower pathway activation as the training set might increase the sensitivity of both EPS and SVD regression to detect subtle increase in TGFβ pathway activation was considered. Therefore, a TGFβ signature was generated using NMuMG cells treated with the lowest dose of TGFβ (0.15 ng/ml) for the shortest period of time (6 hrs) as the training set. This signature was then used to test the ability of SVD and EPS to predict pathway activation at different TGFβ doses.

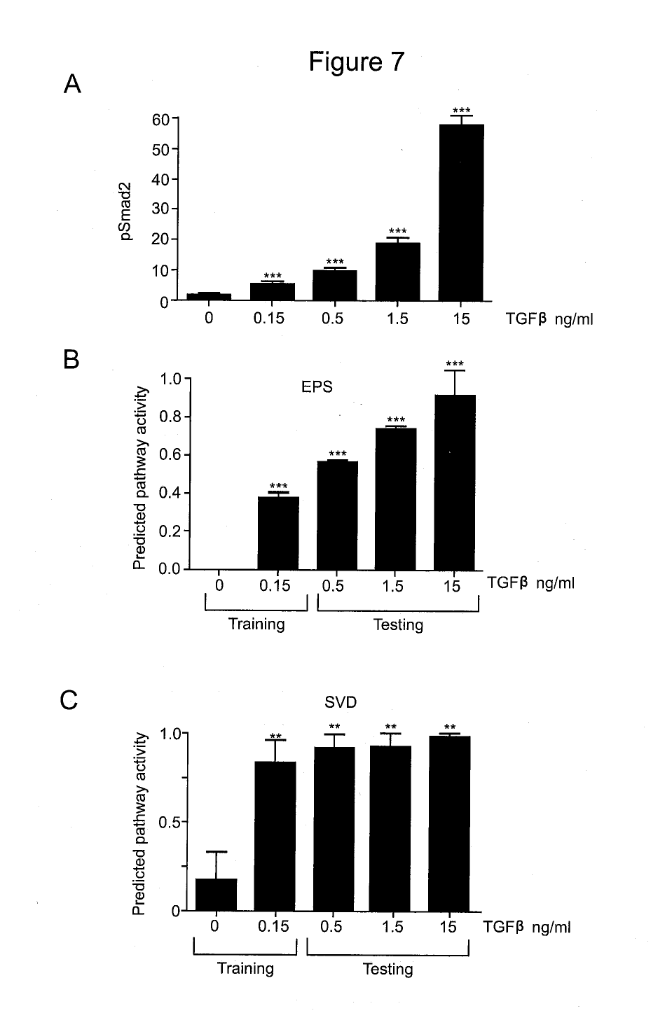

EPS was not only able to detect pathway activation in all TGFβ-treated samples, but also quantitatively estimated the progressive increase of TGFβ pathway activation resulting from treatment with increasing doses of TGF-β1 (FIGS. 7A and 7B). In contrast, while SVD detected pathway activation for each TGF-β1 dose tested, estimated pathway activities did not correlate with the observed increases in biochemical activation of the TGFβ pathway activity as reflected by Smad2 phosphorylation (FIG. 7C). In aggregate, these findings demonstrate that EPS can provide a sensitive and quantitative estimate of the activity of a signaling pathway.

This example illustrates a method for quantitatively assessing activation of a signaling pathway in a testing sample by computing pair-wise energy score and pathway energy score.

### Example 3

### EPS Accurately Detects Signal Pathway Repression

The simulation studies described above in Example 1 (FIG. 5) suggested that EPS, but not SVD, may be able to detect signal pathway repression in test samples exhibiting pathway activities lower than those of the baseline samples in the training set. To evaluate the ability of each algorithm to predict pathway down-regulation in a biological dataset, a published gene expression dataset for four human cancer cell lines in which Myc expression had been suppressed by siRNA-mediated knockdown was used.

A Myc signature was generated based upon genes that were differentially expressed following acute MYC pathway activation in the mouse mammary gland using MMTV-rtTA; TetO-Myc mice. SVD and EPS were then applied to estimate Myc pathway activity in four human cancer cell lines in the presence and absence of Myc knockdown. Myc activity levels, estimated on the basis of microarray data, were compared to the extent of Myc knockdown as measured by QRT-PCR (Cappellen et al.).

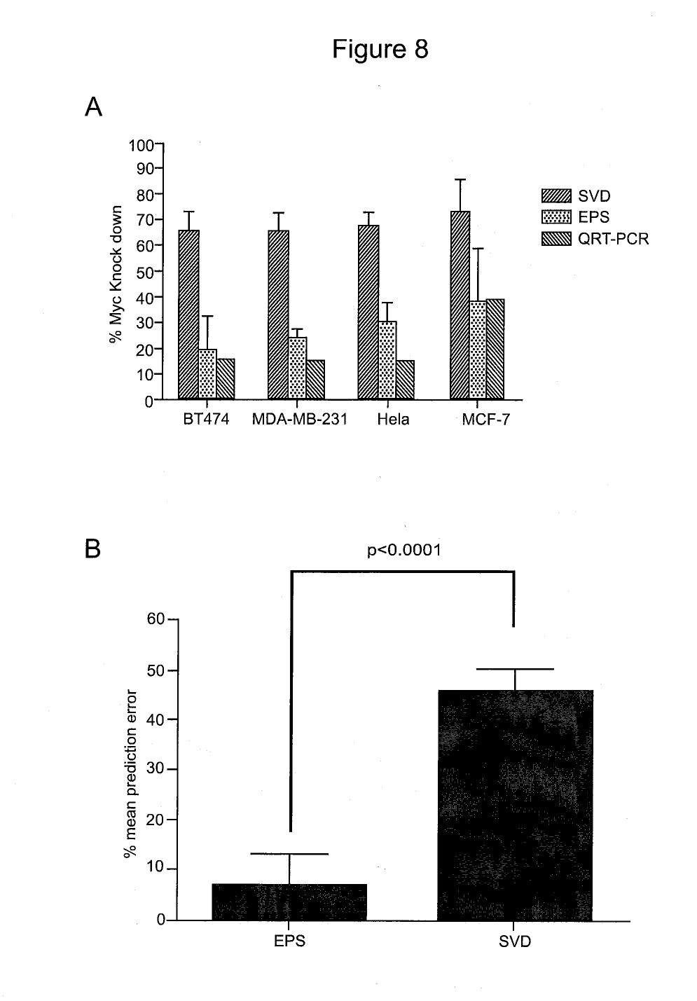

EPS accurately predicted decreased Myc pathway activity in all four lines following siRNA-mediated Myc knockdown (FIG. 8A). Indeed, the magnitude of reduction in Myc pathway activity predicted by EPS closely approximated the extent of Myc knockdown demonstrated by QRT-PCR in each of the four cell lines tested (FIG. 8B). In contrast, SVD regression predicted only minor decreases in Myc pathway activity for each cell line that far underestimated the true extent of knockdown. These results confirm the observations from simulation studies that EPS is better able to detect pathway down-regulation compared to SVD regression.

This example illustrates a method for quantitatively assessing the repression status of a signaling pathway in a testing sample by computing pair-wise energy score and pathway energy score.

### Example 4

### EPS Detects Secondary Activation of Endogenous Signaling Pathways

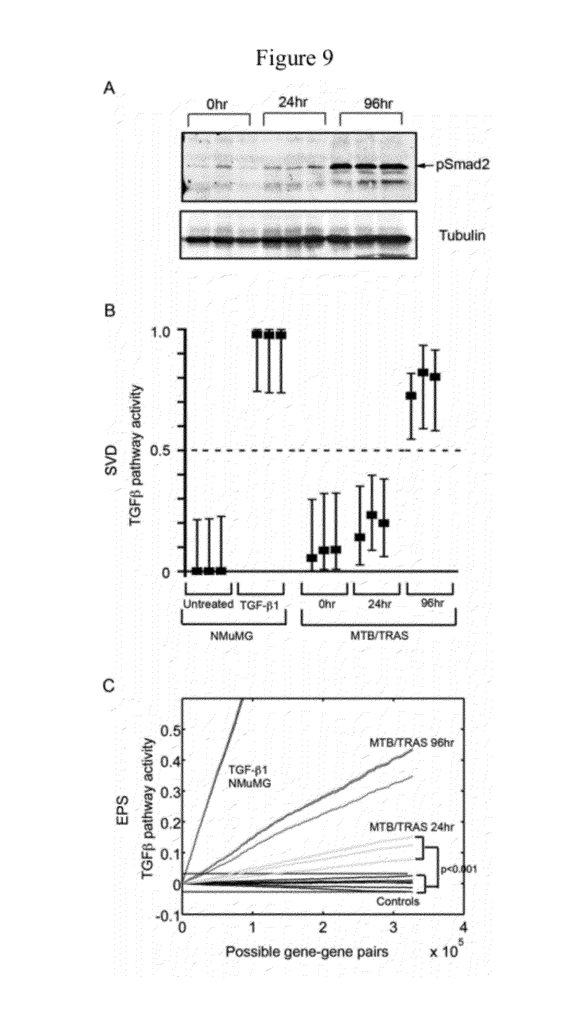

It has been previously demonstrated that crosstalk exists between the TGFβ and Ras pathways in vivo. Biochemical analysis of pSmad2 levels in the mammary glands of doxycycline-induced MMTV-rtTA; TetO-Ras mice revealed that the TGFβ pathway was detectably up-regulated following 24 hr of Ras activation in the mammary gland in vivo and was further up-regulated following 96 hr of Ras activation (FIG. 9A). It was previously demonstrated that SVD regression, in combination with a TGFβ signature generated from TGFβ-treated NMuMG cells, was able to detect elevated TGFβ pathway activity induced in the mammary gland by 96 hr of Ras activation, but was not sensitive enough to detect elevated TGFβ activity induced by 24 hr of Ras activation (FIG. 9B). In contrast, using the same TGFβ signature, EPS was able to detect significantly increased TGFβ activity following 24 hr of Ras activation, as well as further increases in TGFβ activity following 96 hr of Ras activation (FIG. 9C). These findings confirm that EPS is sufficiently sensitive to detect the secondary activation of endogenous signaling pathways in vivo, even when occurring at low levels.

This example illustrates a method for quantitatively assessing activation of a signaling pathway in a testing sample by computing pair-wise energy score and pathway energy score.

### Example 5

### EPS Specifically Detects the Activation of Distinct Oncogenic Signaling Pathways In Vivo

The above results suggested that EPS is a more sensitive and accurate predictor of pathway activity than SVD regression. To compare the specificity of these two approaches, a Myc signature was used to assess Myc pathway activity in three different inducible transgenic mouse models that conditionally express the Myc, Wnt, or neu oncogenes in the mammary gland in response to doxycycline treatment.

Notably, oncogene expression in each model results in the proliferation and expansion of the mammary epithelium. As such, detecting gene expression changes specific to a particular signaling pathway is complicated by the presence of extensive gene expression changes reflecting changes in proliferation as well as changes in epithelial content per se. Consequently, these models could provide a stringent test for the specificity of pathway activity predictions made by EPS and SVD regression.

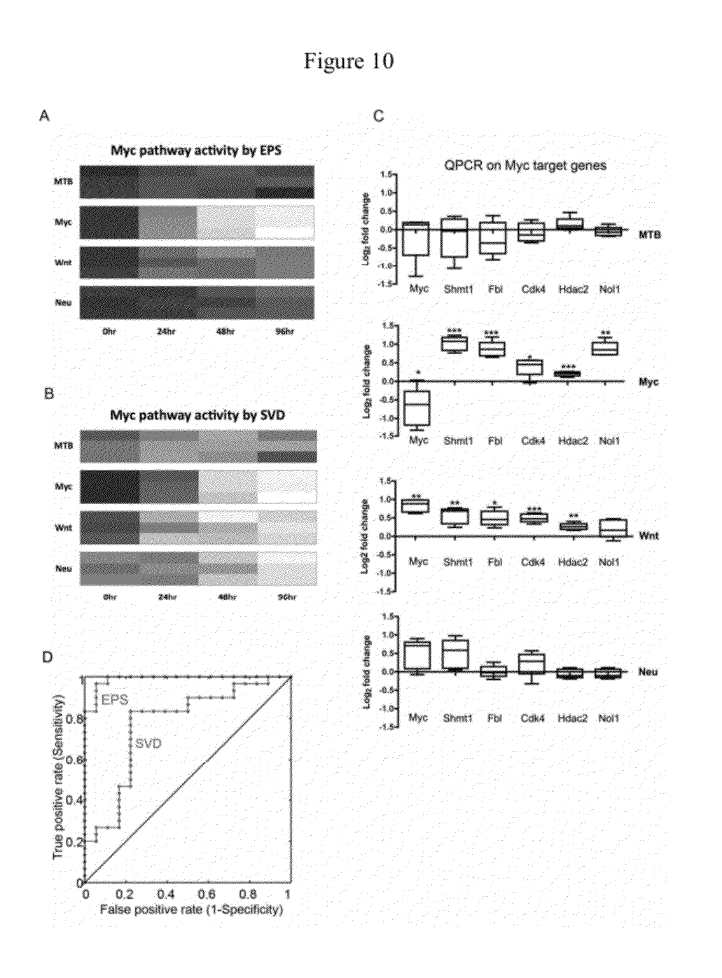

Using a gene expression signature for Myc, EPS detected strong and increasing Myc pathway activation in doxycycline-inducible Myc mice as early as 24 hr following Myc induction in vivo. Moreover, as predicted from the fact that Myc is a downstream effector of the Wnt pathway, EPS detected modest but increasing Myc pathway activation in inducible Wnt1 mice following 24, 48 and 96 hr of Wnt1 induction (FIG. 10A). As predicted, EPS predicted no elevation in Myc pathway activity in inducible neu mice or in MMTV-rtTA controls treated with doxycycline. In contrast, SVD regression failed to predict elevated Myc pathway activity until 48 hr of Myc induction, and predicted increased Myc pathway activity in all three inducible mouse models following 96 hr of oncogene expression (FIG. 10B).

In light of the discrepancy between the predictions for Myc pathway activity made by EPS and SVD regression, molecular methods were used to determine the level of Myc pathway activity in the Myc, Wnt1 and neu inducible mouse models following 96 hr of doxycycline induction. Myc and five of its direct transcriptional targets Shmt1, Fbl, Cdk4, Hdac2, and Nol1 were selected as indicators of Myc pathway activity. All five Myc target genes were significantly up-regulated in Myc inducible mice (FIG. 10C). Moreover, endogenous Myc was significantly down-regulated following Myc transgene induction, consistent with the known negative autoregulation of the Myc locus. Four Myc target genes, in addition to Myc itself, were up-regulated in Wnt inducible mice, as would be predicted based on the known association of Myc as a downstream effector of the Wnt pathway (FIG. 10C). In contrast, no Myc transcriptional targets were up-regulated in neu inducible mice. These findings demonstrate that the Myc pathway is activated in Myc and Wnt1, but not neu, inducible mouse models and confirm that Myc pathway predictions made by EPS are more accurate than those made by SVD regression.

As anticipated, overexpression of a Myc transgene results in repression of endogenous Myc expression, whereas overexpression of Wnt1 results in up-regulation of endogenous Myc expression. SVD regression incorrectly predicts that Neu activation leads to increased Myc activity, whereas EPS accurately predicts that Myc activity is not elevated following Neu activation.

To formally compare the sensitivity and specificity of EPS and SVD regression, Receiver Operating Characteristic (ROC) curves were generated. The area under the ROC curve for EPS was substantially greater than that for SVD regression (FIG. 10D). Taken together, these results demonstrate that EPS is a more sensitive and specific algorithm for predicting pathway activity.

This example illustrates a method for quantitatively assessing the status of a signaling pathway in a testing sample by computing pair-wise energy score and pathway energy score.

### Example 6

### EPS Identifies Specific Chemical Inhibitors of Selected Signaling Pathways

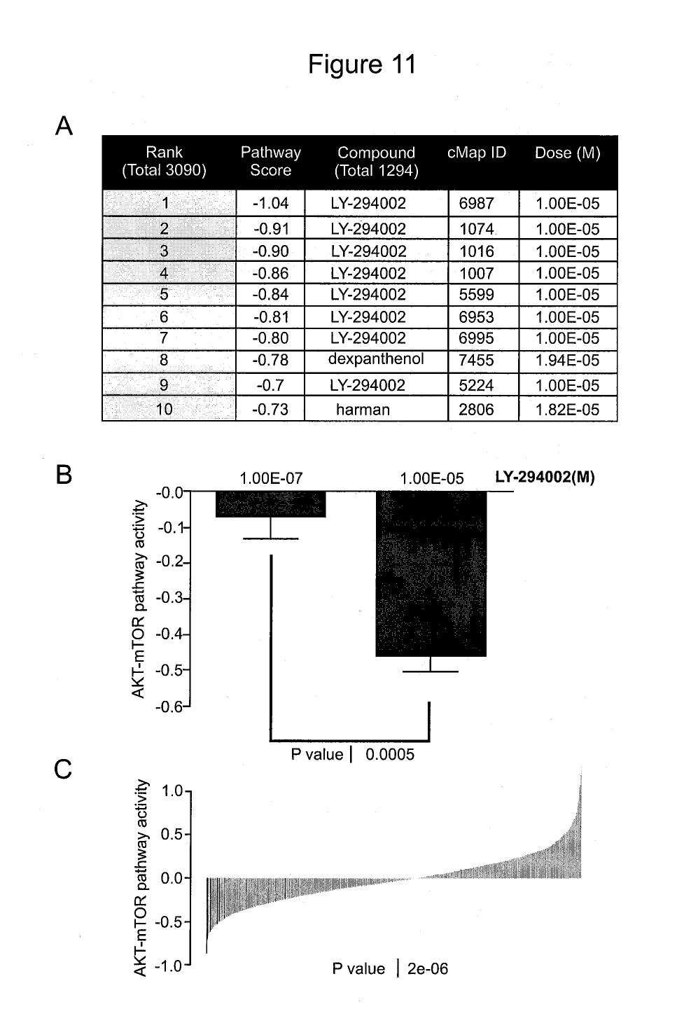

A potential application of EPS is to identify inhibitors of a selected pathway by searching for compounds that induce gene expression changes with a strongly negative pathway score. To test EPS's ability to identify small-molecule inhibitors of a pathway from a large library of compounds, an Akt-mTOR pathway signature was developed using gene expression profiles from the prostates of transgenic mice expressing activated Akt that were treated with either the mTOR inhibitor RAD001 or a vehicle control (Majumder et al.). This signature was used to estimate Akt-mTOR pathway activity in a data set derived from three cell lines that had been treated with 1294 different compounds (Lamb et al.). Use of the EPS algorithm along with this Akt-mTOR signature to query this data set resulted in the identification the PI3K inhibitor LY-294002 as the compound that induced the strongest negative pathway score (FIG. 11A). In fact, test samples treated with LY-294002 represented 8 of the top 9 samples identified (FIG. 11A). In addition, application of EPS demonstrated dose-dependent decreases in Akt-mTOR pathway activity following treatment with increasing concentrations of LY-294002 (FIG. 11B).

These results demonstrate that EPS can be used to specifically identify small-molecule inhibitors of a given pathway from a large library of compounds using gene expression patterns. When combined with EPS's ability to predict pathway activation in human tumors, this approach provides a novel screening strategy to identify drugs that are likely to be effective against particular subsets of human cancers.

This example illustrates a method for screening for an agent that regulates a signaling pathway in a testing sample, wherein the testing sample is treated with the agent, said method by computing pair-wise energy score and pathway energy score.

### Example 7

### Ras Signature Predicts Functional Mutations

Cancers invariably harbor mutations in multiple pathways, and these are thought to collaborate to promote tumorigenesis. The Myc and Ras pathways have been shown to cooperate to induce transformation in vitro and tumor formation in vivo. It has been previously demonstrated by D'Cruz et al. that Ras pathway mutations are spontaneously selected for during the course of mammary tumor formation driven by Myc expression, and tumors with mutant Ras have escaped dependence upon Myc. This model thus offers the opportunity to test whether EPS is able to detect transcriptional changes induced by an endogenous, biologically relevant mutation occurring in the context of a second activated oncogenic pathway.

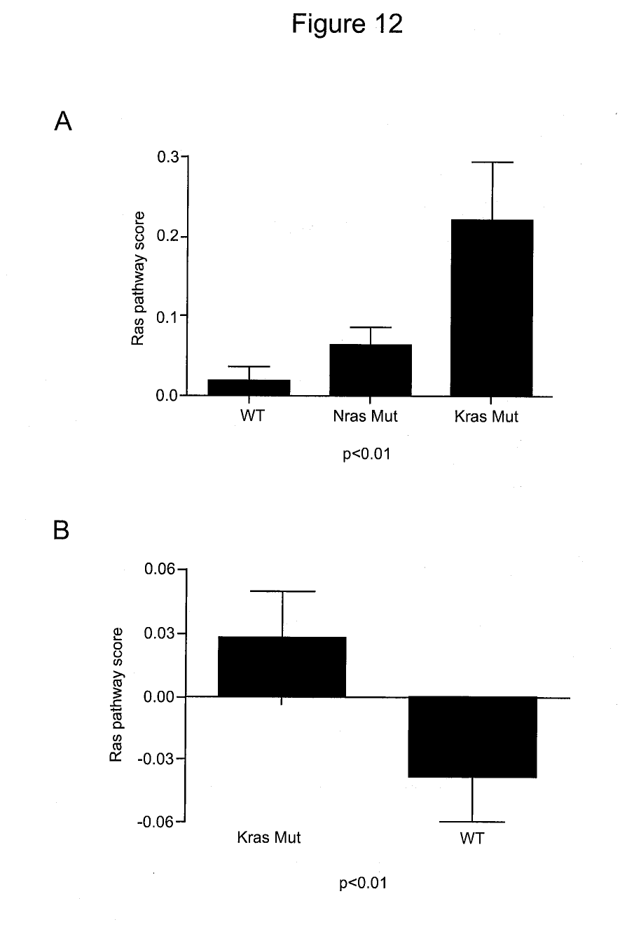

A Ras signature was first generated by comparing mammary gland samples from MMTV-rtTA; TetO-Ras mice following 24 hours of Ras expression to uninduced glands. Signature genes were selected using a p-value of 10⁻⁶ associated with the changes in expression without fold-change cutoff. Then, EPS was used to estimate Ras pathway activity in Myc-driven mammary tumors with wild-type Ras or harboring spontaneous activation of either K-Ras or N-Ras. It was found that activation of the Ras pathway was much stronger in tumors with K-Ras mutations than those with wild-type Ras (FIG. 12A). Tumors with N-Ras mutations had an intermediate level of Ras pathway activity (FIG. 12A). These results are consistent with previous biochemical findings demonstrating a significant increase of both GTP-bound Ras and MAPK activation in Myc tumors with K-Ras mutations. These results suggest that our computational approach is able to detect an endogenous, biologically important mutation even in the presence of a strong transcriptional background driven by ectopic expression of a second oncogene.

In light of these results, it was next tested whether EPS was able to detect Ras mutations in human cancers. EPS was used to estimate Ras pathway activity in lung adenocarcinomas for which K-Ras mutation status had been determined (Sweet-Cordero et al. An oncogenic KRAS2 expression signature identified by cross-species gene-expression analysis. Nat Genet, 2005, 37, 48-55). Tumors with K-Ras mutations demonstrated significantly higher Ras pathway activity compared to those with wild-type Ras (FIG. 12B). These results confirm that EPS can detect pathway activation resulting from a specific mutation even in the context of the complex and widespread transcriptional changes that occur in tumors.

This example illustrates a method for identifying Ras mutations in human cancer by quantitatively assessing the status of a signaling pathway in a testing sample from the cancer patient.

### Example 8

### EPS Specifically Detects Myc Pathway Activity In Vivo

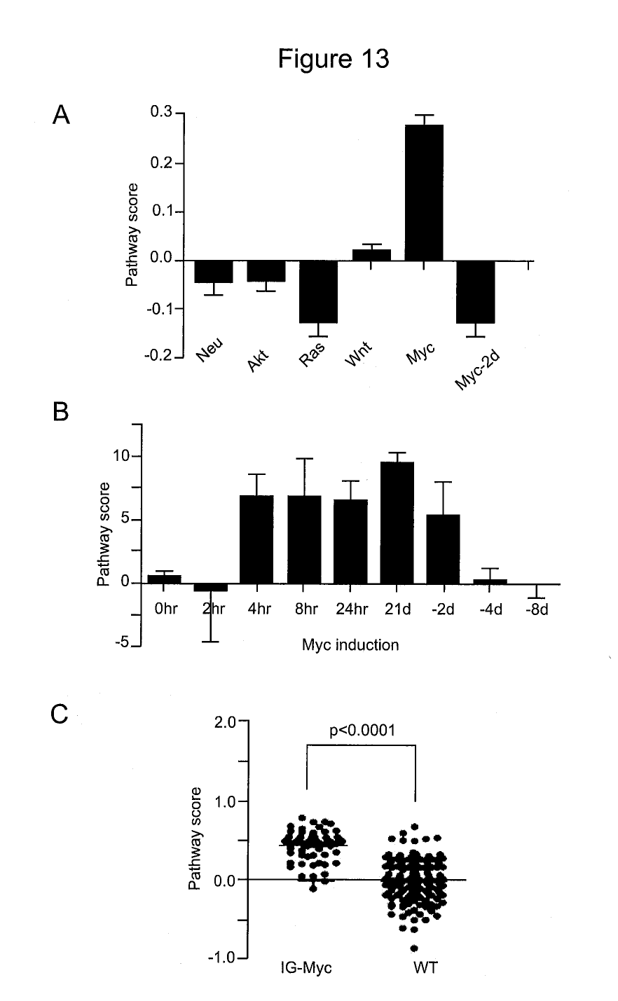

The ability of EPS to predict activity of the Myc pathway in mammary tumors driven by inducible expression of distinct oncogenes was tested. The gene expression profiles of mammary tumors driven by Myc, Wnt, Neu, Akt and Ras were determined by Affymetrix analysis, and EPS was used to estimate Myc pathway activity in tumors of each genotype using a 110-gene Myc signature generated by comparing uninduced MMTV-rtTA; Teto-Myc mice to MMTV-rtTA; Teto-Myc mice induced for 48 and 96 hr at p-value cutoff of less than 0.01 and fold change cutoff of less than 1.5. Tumors were harvested from transgenic mice in which the expression of the oncogenes Myc, Wnt, Neu, Akt or Ras could be induced in the mammary gland by the administration of doxycycline to mice in their drinking water. The Myc-inducible system was described by D'Cruz et al. The HER2/neu-inducible system was described by Moody et al (2002). The Wnt-inducible system was described by Gunther et al, and included two subsets of mice that were either wildtype or heterozygous for a null allele of p53. The Akt-inducible system was described by Boxer et al (2006). The Ras-inducible system was described by Sarkisian et al. Myc-driven tumors displayed significantly elevated activity of the Myc pathway, validating EPS as a means for assessing pathway activity (FIG. 13A). Importantly, tumors driven by Neu, Akt, and Ras had much lower Myc pathway activity, indicating that EPS can specifically detect Myc pathway activity, and is not just detecting transcriptional changes associated with transformation or proliferation (FIG. 13A). Wnt-driven tumors had intermediate levels of Myc pathway activity, consistent with a role for Myc as a downstream mediator or Wnt signaling (FIG. 13A).

As another test of the specificity of the Myc signature, Myc activity was estimated in tumors 2 days after down-regulation of Myc expression. This time-point precedes gross changes in tumor size, and so analyzing tumors at this point should provide a specific means of assessing Myc-dependent transcriptional changes. Indeed, EPS predicted Myc pathway activity to be significantly decreased following Myc deinduction, confirming that the signal detected by EPS was specific for Myc (FIG. 13A). As anticipated, Myc-expressing tumors exhibited strongest activation of the Myc pathway, followed by Wnt-expressing tumors, and EPS-predicted Myc pathway activity was rapidly down-regulated following de-induction of Myc for 2 days.

The ability of EPS to measure Myc pathway activity in a different cell type was assessed by analyzing transcriptional changes induced by short-term Myc induction and de-induction in pancreatic beta cells (Lawlor et al). EPS detected Myc pathway activity as early as 4 hours after Myc activation, and the pathway remained activated through 21 days of Myc activation (FIG. 13B). Following loss of Myc activation, Myc pathway activity was decreased partially at 2 days and returned to baseline at 4 and 8 days (FIG. 13B). These results confirm that EPS can detect acute and reversible changes in activation of the Myc pathway in diverse cell types.

This example illustrates a method for quantitatively assessing the status of a signaling pathway in a testing sample by computing pair-wise energy score and pathway energy score.

### Example 9

### EPS Detects Lymphomas with an IG-Myc Fusion

To test whether EPS can detect pathway activation resulting from genetic aberrations in human cancers, Myc pathway activity in a cohort of 220 lymphoma patients was analyzed (Hummel et al.). This cohort comprised both Burkitt's lymphomas and diffuse large B cell lymphomas, two subtypes that are difficult to distinguish using traditional histological criteria but differ in their molecular and transcriptional profiles, with Burkitt's lymphomas being characterized by the presence of an IG-Myc translocation and consequent activation of the Myc pathway. Estimation of Myc pathway activity in these patients using EPS revealed significantly higher pathway activation in patients with IG-Myc fusions compared to those with wild-type Myc (FIG. 13C). Given the complex genomic and gene expression aberrations in lymphomas, the ability to detect Myc pathway aberration is important to therapy selection.

This example illustrates a method for identifying specific lymphomas having activated Myc pathway by quantitatively assessing the status of a signaling pathway in a testing sample.

### Example 10

### EPS Detects Accurately Loss of p53 in Wnt Tumors

The loss of tumor suppressor genes, occurring through point mutations, genomic aberrations, or epigenetic mechanisms, is an important step in tumorigenesis. An accurate assessment of the status of tumor suppressor pathways in human cancers is critical, as the functional status of these pathways is an important determinant of a tumor's progression and response to therapy. In this study, EPS was used to detect the loss of a tumor suppressor in tumors.

A p53 signature was generated by comparing the expression profiles of rat embryo fibroblasts expressing a temperature sensitive SV40 allele, tsA58, at the permissive and restrictive temperatures (Godefroy et al). Genes whose expression changed by at least 1.5-fold with a p-value less than 0.001 were included in the signature.

The status of the p53 pathway activity was estimated in mammary tumors driven by Neu (MTB/TAN) or Wnt1 (MTB/TWNT), as well as Wnt1-driven tumors arising in mice lacking one p53 allele (MTB/TWNT; p53+/−). It was previously demonstrated by Gunther et al. that a fraction of MTB/TWNT; p53+/− tumors had undergone loss-of-heterozygosity, and these tumors had escaped dependence upon Wnt signaling, suggesting a functional relevance for the p53 pathway in this context.

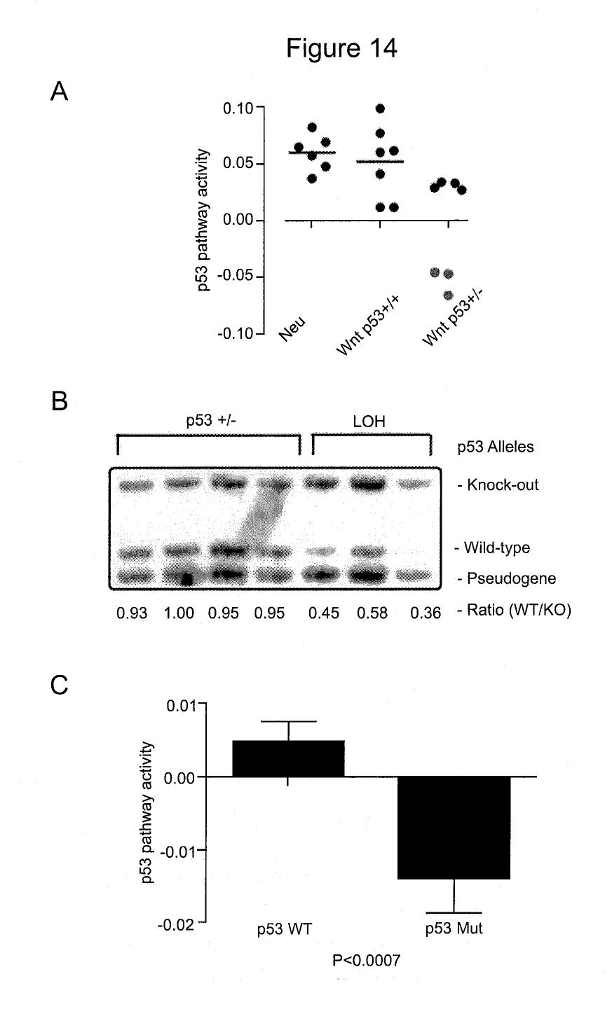

Both MTB/TAN and MTB/TWNT; p53+/+ tumors had detectable p53 pathway activity (FIG. 14A). In contrast, a subset of MTB/TWNT; p53+/− tumors had significantly lower p53 pathway activity, suggesting these tumors may have undergone LOH (FIG. 14A). To directly test this, Southern blot analysis was performed to examine the wild-type p53 allele in these tumors. Consistent with the prediction made by EPS, tumors with low p53 pathway activity demonstrated partial or complete loss of the wild-type p53 allele (FIG. 14B). Thus EPS provides a sensitive means of assessing the p53 pathway in Wnt-driven tumors, providing insight into a suppressor pathway that functionally regulates tumor progression.

p53 mutations occur in a subset of human breast cancers and are correlated with poor outcome. While p53 status can be inferred from immunohistochemical staining or direct gene sequencing, there are other mechanisms by which the p53 pathway can be inactivated. To determine whether EPS could provide a general means of assessing the status of the p53 pathway, EPS was used to measure p53 pathway activity in breast cancers (Miller et al) whose p53 status was determined by immunohistochemistry (IHC). Tumors with wild-type p53 were found to have significantly higher activation of the p53 pathway compared to tumors with mutant p53 (FIG. 14C).

Together these results demonstrate that EPS can be used to assess the status of tumor suppressor pathways in tumors. Given the many distinct methods by which tumor suppressor function can be compromised in tumors, it is essential to have a robust and general means for measuring their function. These results suggest that EPS may provide such a method.

This example illustrates a method for detecting the loss of a tumor suppressor in tumors by quantitatively assessing the status of a signaling pathway in testing samples from the tumors.

### Example 11

### AKT Signature Activity is Linked to Multiple Factors in EGFR-PTEN-PI3K Pathway

With the development of high-throughput sequencing and array CGH technology, the genome landscape of tumors cells has been revealed to bear many mutations and copy number aberrations. Based on these observations, the activation status of a given pathway can be influenced by mutations or copy number aberrations occurring at many separate nodes in that pathway. Therefore, assays on single genes (such as HER2/neu or Ras) may not yield accurate pathway status; in contrast, pathway signatures are more likely to provide an integrated analysis of the output of a signaling pathway.

Activation of the Akt pathway can occur at multiple nodes, including mutation of PIK3CA, loss of PTEN, and amplification of Akt, and so this pathway offers the opportunity to test EPS's ability to integrate individual mutations and amplifications into a consensus output of pathway activity. An Akt pathway signature was first generated from prostate cancer cells (Majumder et al) expressing activated Akt, and EPS was used to apply the signature to a group of glioblastoma patients (Cancer Genome Atlas Research Network, 2008) whose genomic landscape and transcriptional profile had been surveyed through a joint effort by the Cancer Genome Atlas consortium. This included determination of gene mutations by sequencing and genomic copy number by CGH arrays.

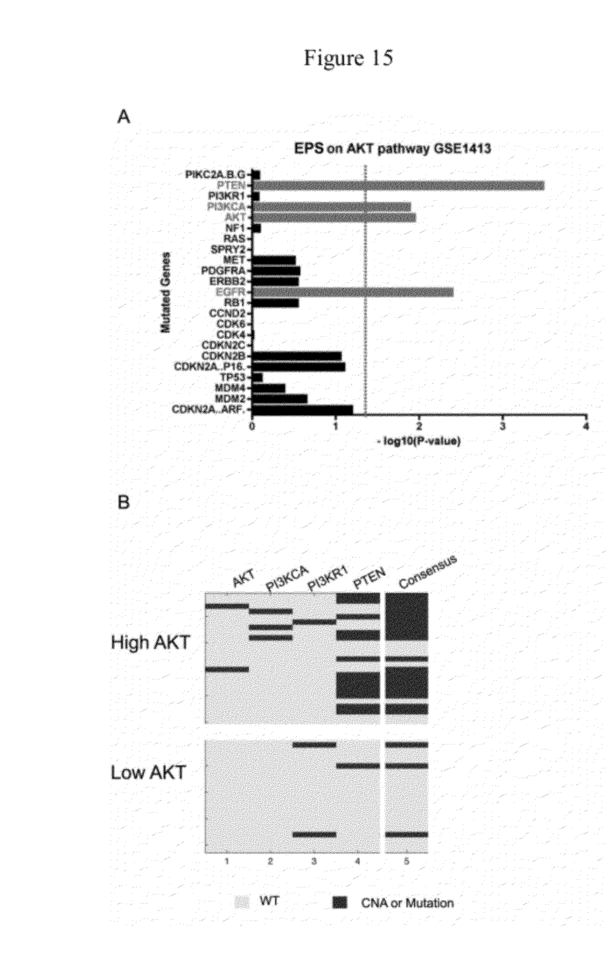

Activation of the Akt pathway was estimated for each tumor, and the correlation between pathway activation and a given genetic alteration was assessed. The p-value of the correlation coefficency for each gene was determined. Among the genes whose mutational status was determined, EGFR, PTEN, PI3KCA, and AKT mutations are significantly correlated with predicted Akt pathway activity (FIG. 15A). This result suggests that the computationally estimated pathway activity can accurately identify tumors with activation of the Akt pathway. Additionally, it indicates that mutations and copy number aberrations at multiple key regulators can contribute to the overall pathway activity.

Next, the distribution of mutations in Akt, PIK3CA, PI3KR1, and PTEN was examined to generate a consensus Akt pathway mutation status for each tumor. Tumors with mutations in at least one component of the Akt pathway had significantly higher pathway activity than patients with no mutations (FIG. 15A). This result confirms that mutations at multiple points of a given pathway can contribute to activation of that pathway.

This example illustrates a method for quantitatively assessing the status of a signaling pathway in a testing sample by computing pair-wise energy score and pathway energy score.

### Example 12

### Identification of Ras Mutations in Lung Cancer Cell Lines and Patients

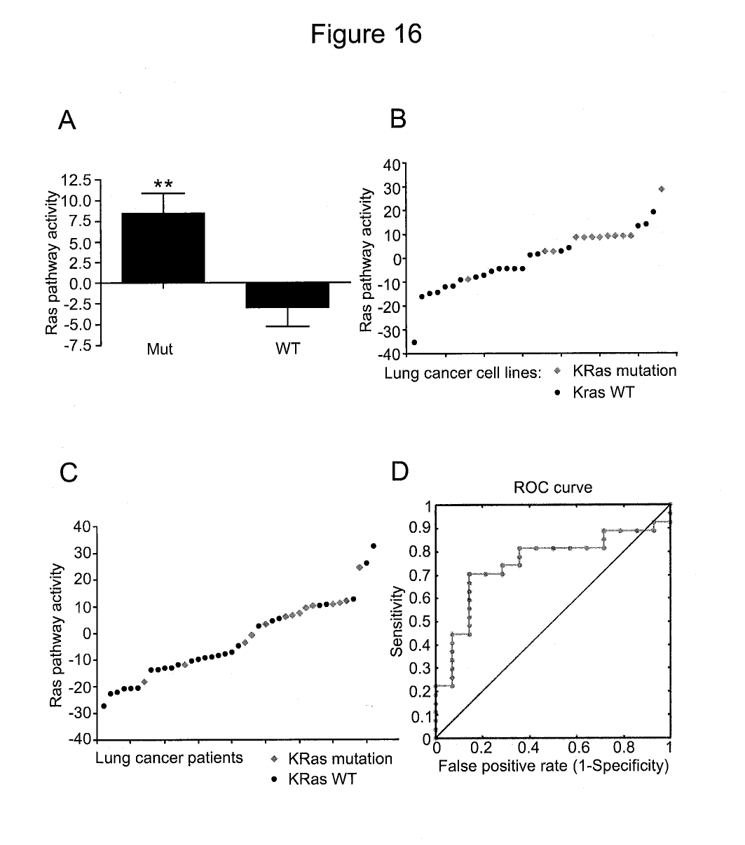

To further access EPS's ability to identify oncogenic mutations in cancer, a Ras pathway signature (Bild et al), which was generated from human mammary epithelial cells overexpression activated H-Ras, was applied to a collection of lung cancer cell lines (Coldren et al). When these cell lines were grouped by their Ras mutations status, EPS predicted a higher level of Ras pathway activation in the subset of cell lines containing activating mutations in Kras, compared to cell lines wild type for Kras (FIG. 16A).

Next, the relationship between predicted Ras pathway activity and the presence of activating mutations in Kras was evaluated in individual lung cancer cell lines. When plotting Ras pathway activity for each cell line revealed that cell lines with higher Ras pathway activity level were significantly enriched for Kras mutations (FIG. 16B).

To evaluate the sensitivity and specificity of EPS's ability to predict oncogenic mutations in human lung cancer patients, the Ras signature was applied to a set of human lung cancers (Ding et al). When the predicted Ras pathway activity of each cancer was plotted in ascending order, Ras mutations were found to be significantly enriched in the patients with higher Ras pathway activity (FIG. 16C).

Finally, to analyze the sensitivity and specificity of our prediction algorithm, a Receiver Operating Characteristic (ROC) analysis was performed (FIG. 16D). This revealed that the EPS Ras pathways predictor was able to identify human lung cancers bearing Kras mutations with 85% specificity and 70% sensitivity.

This example illustrates a method for identifying Ras mutations in lung cancer cell lines and patients by quantitatively assessing the status of a signaling pathway in testing samples of the cell lines or from the patients.

### Example 13

### State Prediction of Epithelial-to-Mesenchymal Transition

An epithelial-to-mesenchymal (EMT) gene expression signature was generated by comparative analysis of microarray data between 10 epithelial breast cancer cell lines and 5 mesenchymal-like breast cancer cell lines (Choi et al.). Microarray data for the 15 cell lines were downloaded from NCBI GEO data set GSE13915. The EMT signature consisted of 1186 genes differentially expressed between the two groups of cell lines at a false discovery rate of less than 0.05. Differential expression analysis was performed using Cyber-T (Baldi et al.).

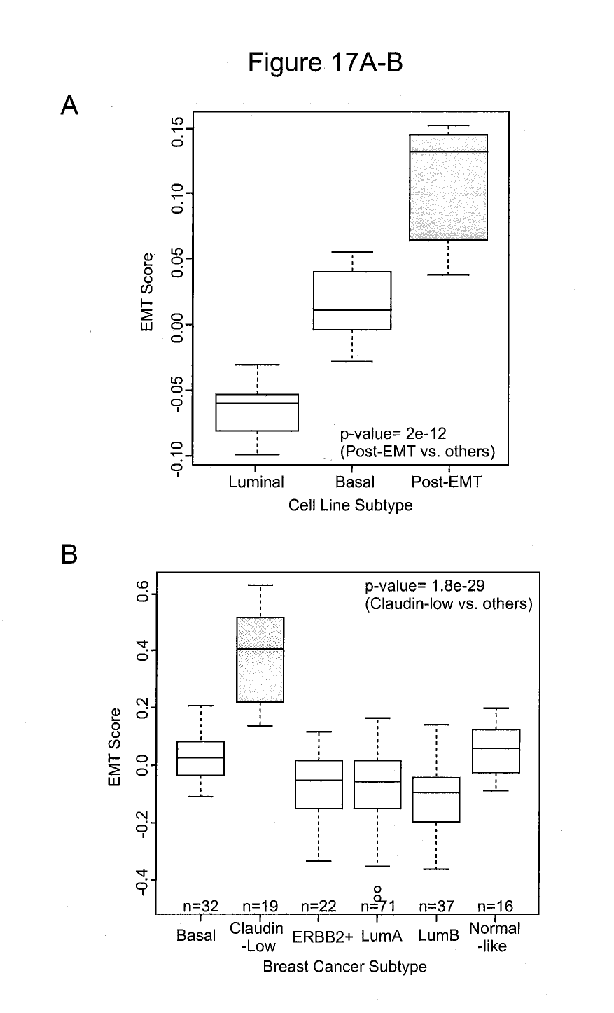

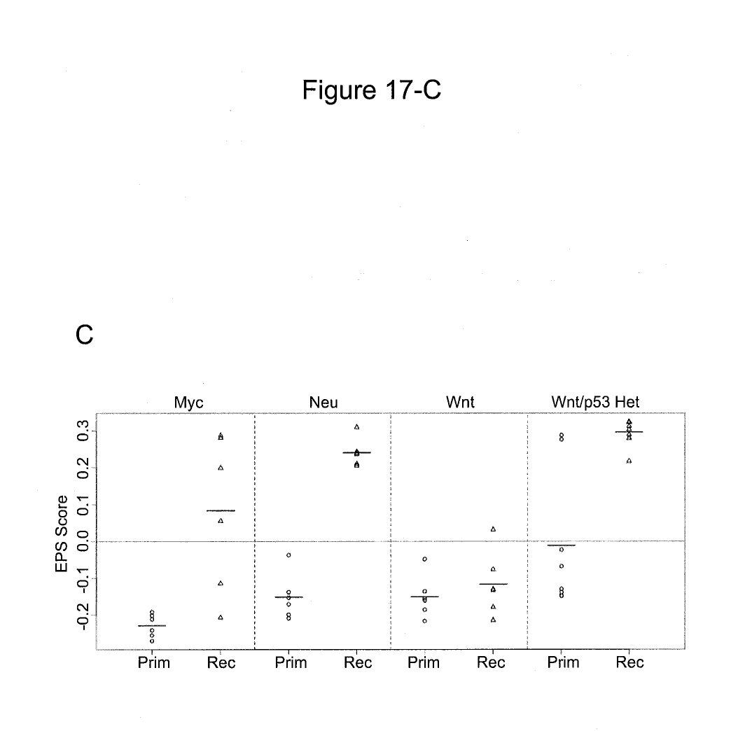

Using the EMT signature, EPS-predicted EMT scores were generated for each cell line in an independent panel of 44 breast cancer cell lines (Finn et al.). Microarray data for the 44 breast cancer cell lines were downloaded from NCBI GEO data set GSE18496. Cell lines were classified into three subtypes (luminal-like, basal-like and post-EMT) by Finn et al based on marker gene expression. Only those cell lines bearing a subtype designation were analyzed by EPS. Cell lines predicted to be post-EMT by EPS were defined as having EMT scores higher than 2 median absolute deviations (MAD) above the median. Using these criteria, EPS prediction achieved 100% sensitivity and 91% specificity in detecting cell lines classified as post-EMT by Finn et al. FIG. 17A shows the distribution of EPS-predicted EMT scores in the 44 breast cancer cell lines using standard box plot (Tukey), which demonstrated that—as anticipated based on the prior characterization of these cell lines—prediction scores were substantially higher for the post-EMT subtype of cell lines than in the other two subtypes (p=2e−12).

EPS-predicted EMT scores were also generated for a breast cancer data set consisting of a cohort of 197 breast cancer patients (Prat et al.). Microarray data for the breast cancer data set were downloaded from NCBI GEO data set GSE18229. Since this data set contained data from multiple platforms, only the data obtained from the modal platform, GEO platform GPL1390, were analyzed by EPS. The samples in GSE18229 were classified into six subtypes (Basal, ERBB2+, Luminal A, Luminal B, Normal-like and Claudin-low) by Prat et al based on microarray gene expression profiles. The Claudin-low subtype had been characterized and reported to be enriched in post-EMT features (Prat et al., Herschkowitz et al., Hennessy et al.). Post-EMT samples predicted by EPS were defined as having EMT scores higher than 2 median absolute deviations (MAD) above the median. Using these criteria, EPS prediction achieved 89% sensitivity and 97% specificity in detecting breast cancer samples classified as Claudin-low by Finn et al. FIG. 17B shows the distribution of EPS-predicted EMT scores in the 197 breast cancer patients using a standard box plot, in which prediction scores were demonstrated to be substantially higher in the Claudin-low subtype than in the other five subtypes of human breast cancer (p=1.8e−29).

EPS-predicted EMT scores were also generated for a set of transgenic mouse mammary tumors. These tumors were harvested from transgenic mice in which the expression of the oncogenes Myc, Neu or Wnt could be induced in the mammary gland by the administration of doxycycline to mice in their drinking water. The Myc-inducible system was described by D'Cruz et al. The HER2/neu-inducible system was described by Moody et al. The Wnt-inducible system was described by Gunther et al, and included two subsets of mice that were either wildtype or heterozygous for a null allele of p53. In each transgenic system, primary tumors were formed as a result of chronic oncogene expression induced by chronic doxycycline administration, whereas recurrent tumors were derived from primary tumors that had regressed to a non-palpable state following doxycycline withdrawal and oncogene down-regulation, but had subsequently recurred spontaneously in the absence of doxycycline treatment (Moody et al. 2005, Gunther et al., Boxer et al. 2004). For each genotype, 6-8 primary and 6-8 recurrent tumors were analyzed by EPS. FIG. 17C shows EMT scores for the primary and recurrent transgenic mouse mammary tumors induced by these different oncogenes. Tumors that had very high EMT scores included three Myc recurrent tumors, all HER2/neu recurrent tumors, two Wnt/p53 heterozygous primary tumors and all Wnt/p53 heterozygous recurrent tumors. All of the tumors with high EMT scores, and for which histology was known, exhibit mesenchymal-like spindle-cell phenotype. All of the Myc, HER2/neu and Wnt/p53 wildtype primary tumors, as well as all of the Wnt/p53 wildtype recurrent tumors, had low predicted EMT scores, consistent with the observed lack of mesenchymal-like phenotype in those tumors.

An analogous approach may be used (with other signatures) to detect other “states”. For example, a gene expression or proteomic signature could be derived that reflects a disease state in a diagnostic tissue of interest, such as diabetes (in fat, muscle or serum), ulcerative colitis (in colon or serum), or Alzherimer's Disease (serum or cerebrospinal fluid). EPS could then be use in concert with these signatures to sensitively and specifically detect the presence of the disease (i.e., as a diagnostic measure).

### Example 14

### Process Prediction

### Proliferation

A proliferation gene expression signature was generated by intersecting genes responding to serum in human fibroblasts (serum-response signature) with genes periodically expressed in synchronous Hela cells (cell cycle signature). The serum-response signature was generated using microarray data of human fibroblasts from 10 different anatomic sites (Chang et al. http://microarray-pubs.stanford.edu/wound/). Gene expression changes between 25 fibroblast samples growing in 0.1% serum and another 25 samples growing in 10% serum were compared using Cyber-T (Baldi et al.). 1882 genes differentially expressed at a false discovery rate of less than 0.005 were defined as the serum-response signature. The cell cycle signature was taken from Whitfield et al. and included 651 genes periodically expressed in synchronous Hela cells as determined by Fourier transformation, ideal profile correlation and autocorrelation. The proliferation signature used here contained the 224 genes common to the serum-response and cell cycle signatures.

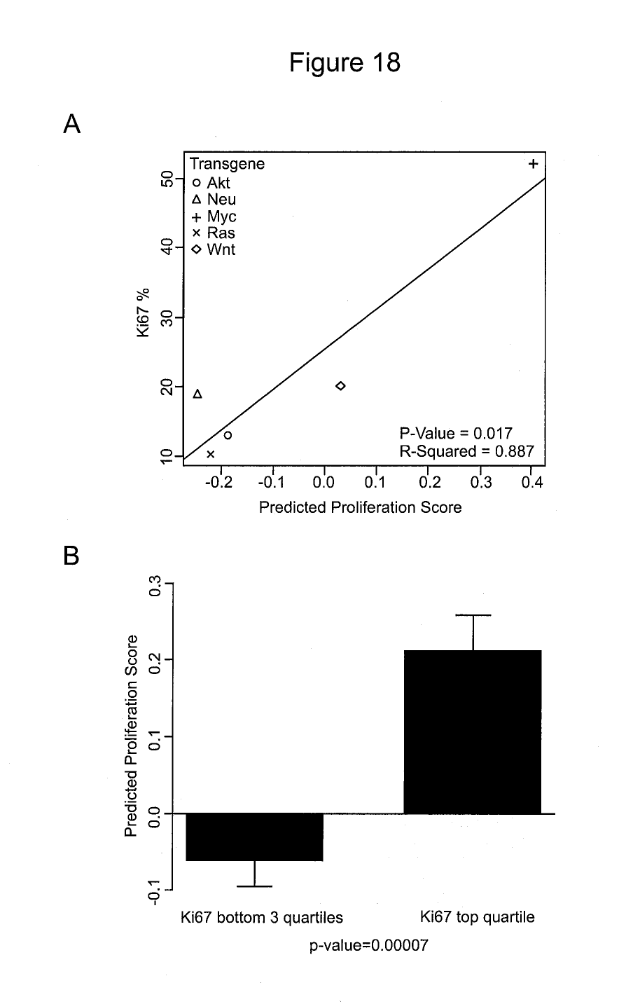

Using this signature, EPS-predicted proliferation scores were generated for a set of transgenic mouse primary mammary tumors. The tumors were harvested from animals harboring doxycycline-inducible Akt, Myc, Neu, Ras or Wnt oncogene. The Akt inducible system was described by Boxer et al, 2005. The Myc inducible system was described by D'Cruz et al. The HER2/neu inducible system was described by Moody et al, 2002. The Ras inducible system was described by Sarkisian et al. The Wnt inducible system was described by Gunther et al. Primary tumors were generated in these mice by chronic administration of doxycycline, as described in FIG. 1 in Gunther et al. Six primary tumors from each of the transgenic systems were profiled by gene expression microarrays and analyzed using EPS. The percentage of cells staining positively for Ki67 protein by immunofluorescence, which is an accepted measure of cellular proliferation, was determined in an independent set of murine transgenic primary mammary tumors from the same five inducible systems, with six tumors from each system. As shown in FIG. 18A, average EPS-predicted proliferation scores were highly correlated with the genotype-average Ki67 percentages (p=0.017, R²=0.89). This indicates that EPS prediction can explain almost 90% of the variation in proliferation observed across mammary tumors induced by different oncogenic pathways, demonstrating that EPS can accurately predict the rate of proliferation in in vivo tissue samples. Negative prediction scores indicate samples with below-average proliferation, rather than negative proliferation.

EPS-predicted proliferation scores were also generated for a set of human breast tumors from a cohort of 118 breast cancer patients (Chin et al) for which Ki67 measurements had been performed. Microarray data for the Chin data set were downloaded from http://cancer.lbl.gov/breastcancer/data.php. In this human tumor data set, EPS-predicted proliferation scores were significantly higher in the most proliferative (top 25% Ki67) tumors (FIG. 18B, p=0.0007). In the figure, negative prediction scores correspond to below-average proliferation, rather than negative proliferation. This demonstrates that EPS can predict proliferation rates in human cancers using only microarray data.

An analogous approach may be used (with other signatures) to detect other “processes”. For example, gene expression or proteomic signatures could be derived that reflect apoptosis or cellular senescence. EPS could then be use in concert with these signatures to sensitively and specifically detect the presence of apoptosis or cellular senescence in a sample or tissue.

### Example 15

### Environmental Toxin Exposure

Gene expression signatures were generated from microarray data of C. elegans treated with 50 mg/L dichlorvos, 200 mg/L fenamiphos (both organophosphate pesticides) or 500 mg/L mefloquine (Lewis et al, GEO data set GSE12298). Signatures were generated to reflect gene expression changes specific to each of the toxins (compound-specific signatures), or specific to the organophosphate pesticide (OP) group (OP-specific signature).

The dichlorvos-specific signature was generated from three different signatures. The first signature contained 1587 probe sets differentially expressed between dichlorvos-treated and control samples at a false discover rate cutoff of less then 0.001 and a fold change cutoff of greater than 2. The second signature contained 8529 probe sets differentially expressed between fenamiphos-treated and control samples at a false discovery rate cutoff of less than 0.25. The third signature contained 10565 probe sets differentially expressed between mefloquine-treated and control samples at a false discovery rate cutoff of less than 0.25. The dichlorvos-specific signature was formed by removing any probe sets that were in the second or the third signature from the first signature, resulted in a final signature of 28 probe sets.

The fenamiphos-specific signature was generated from three different signatures. The first signature contained 1371 probe sets differentially expressed between fenamiphos-treated and control samples at a false discover rate cutoff of less then 0.001 and a fold change cutoff of greater than 2. The second signature contained 8905 probe sets differentially expressed between dichlorvos-treated and control samples at a false discovery rate cutoff of less than 0.25. The third signature contained 10564 probe sets differentially expressed between mefloquine-treated and control samples at a false discovery rate cutoff of less than 0.25. The fenamiphos-specific signature was formed by removing any probe sets that were in the second or the third signature from the first signature, resulted in a final signature of 16 probe sets.

The mefloquine-specific signature was generated from three different signatures. The first signature contained 2237 probe sets differentially expressed between mefloquine-treated and control samples at a false discover rate cutoff of less then 0.001 and a fold change cutoff of greater than 2. The second signature contained 8905 probe sets differentially expressed between dichlorvos-treated and control samples at a false discovery rate cutoff of less than 0.25. The third signature contained 8528 probe sets differentially expressed between fenamiphos-treated and control samples at a false discovery rate cutoff of less than 0.25. The mefloquine-specific signature was formed by removing any probe sets that were in the second or the third signature from the first signature, resulted in a final signature of 339 probe sets.

The OP-specific signature was generated from three different signatures. The first signature contained 1586 probe sets differentially expressed between dichlorvos-treated and control samples at a false discover rate cutoff of less then 0.001 and a fold change cutoff of greater than 2. The second signature contained 1371 probe sets differentially expressed between fenamiphos-treated and control samples at a false discovery rate cutoff of 0.001 and a fold change cutoff of greater than 2. The third signature contained 10564 probe sets differentially expressed between mefloquine-treated and control samples at a false discovery rate cutoff of less than 0.25. The OP-specific signature was formed by removing any probe sets that were in the third signature from the overlap of the first and the second signatures, resulted in a final signature of 60 probe sets.

Compound-specific signatures contain genes differentially expressed between samples treated with one of the three compounds and the corresponding control samples at high stringency cutoffs, while excluding genes differentially expressed between samples treated with either of the other two compounds and the corresponding control samples at low stringency cutoffs. High stringency cutoffs were defined as having a false discovery rate of less than 0.001 and a fold change of greater than 2. Low stringency cutoffs were defined as having a false discovery rate of less than 0.25. The OP-specific signature contains genes differentially expressed between samples treated with either dichlorovos or fenamiphos and the corresponding control samples at high stringency cutoffs, while excluding genes differentially expressed between samples treated with mefloquine and the corresponding control samples at low stringency cutoffs.

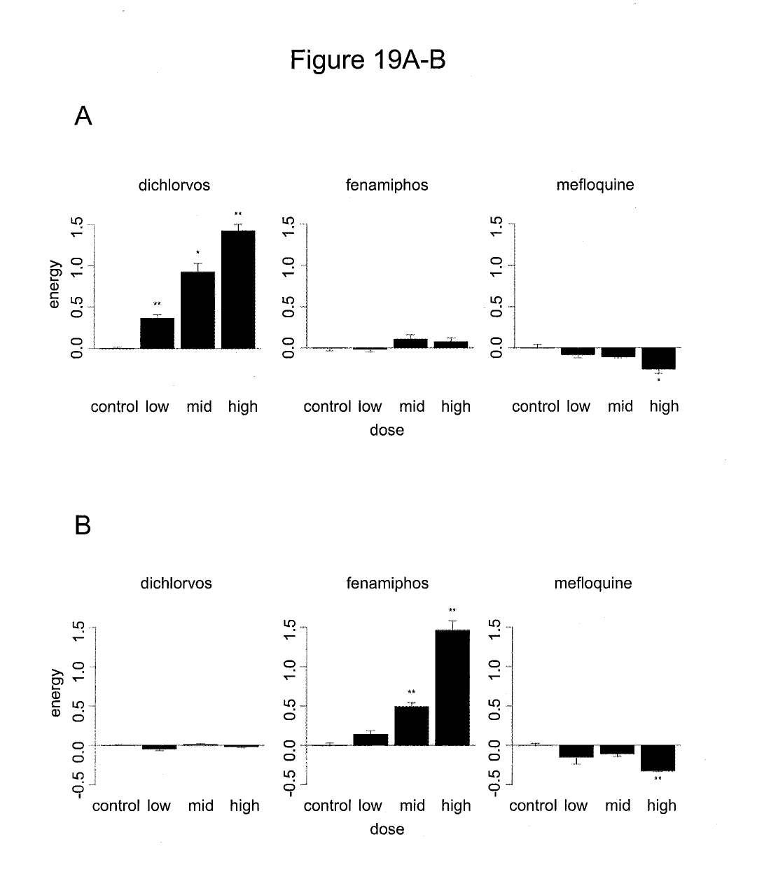

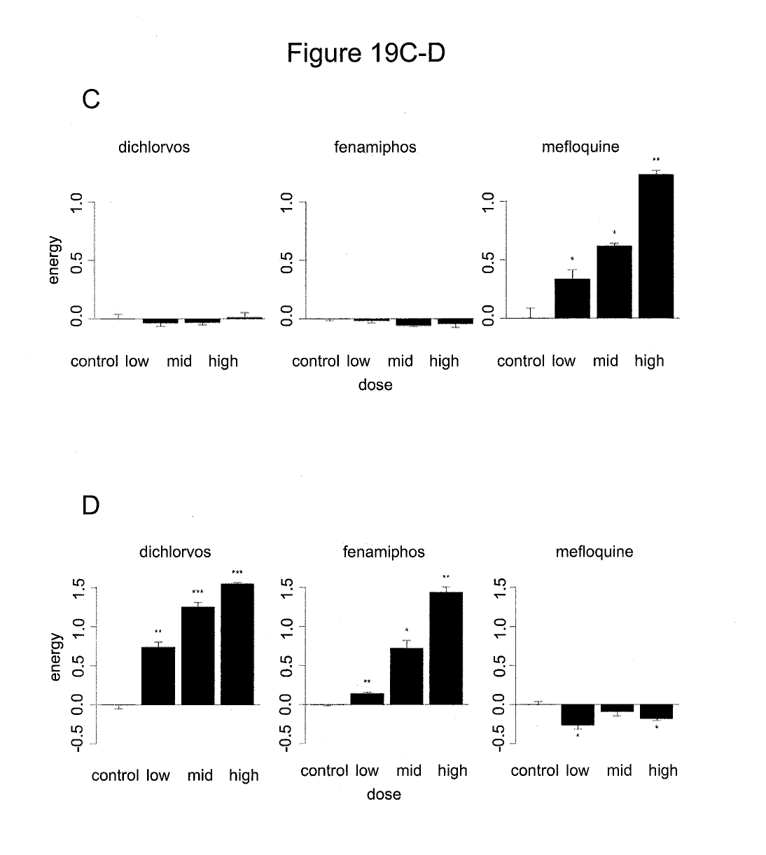

Using the dichlorvos-specific signature to generate detection scores, EPS was able to detect exposure to intermediate (15 mg/L) and low (3 mg/L) doses of dichlorvos, as well as avoid detecting exposure to any doses of the other two compounds (FIG. 19A). This indicates that the dichlorvos signature is both sensitive and specific when applied using the EPS algorithm. Using the fenamiphos-specific signature to generate detection scores, EPS was able to detect exposure to intermediate dose (60 mg/L) of fenamiphos as well as avoid detecting exposure to any doses of the other two compounds (FIG. 19B). This indicates that the fenamiphos signature is both sensitive and specific when applied using the EPS algorithm. Using the mefloquine-specific signature to generate detection scores, EPS was able to detect exposure to intermediate (250 mg/L) and low (10 mg/L) doses of mefloquine, as well as avoid detecting exposure to any doses of the other two compounds (FIG. 19C). This indicates that the mefloquine signature is both sensitive and specific when applied using the EPS algorithm. Using the OP-specific signature to generate detection scores, EPS was able to detect low and intermediate doses of both OP compounds, as well as avoid detecting exposure to any doses of mefloquine (FIG. 19D). This indicates that the OP-specific signature is both sensitive and specific when applied using the EPS algorithm. Samples with negative prediction scores in FIG. 19 were samples that had gene expression patterns that were more dissimilar to patterns caused by the prediction target compound, compared to the difference between gene expression patterns in control samples and gene expressions patterns caused by the prediction target compound. Overall, these EPS-generated predictions were consistent with—but more sensitive than—results reported by Lewis et al.

### Example 16

### EPS-Predicted Drug Exposure Using Proteomics Data

Plasma protein signatures were generated from SELDI high-throughput proteomics data from rats treated with high doses of one of 9 drug compounds for 3 days (Suter et al.; data were downloaded from http://www.ebi.ac.uk/bioinvindex/). High and low doses were defined for each compound as described in Suter et al. There were five animals in each sample group. For each animal, there were four technical replicates. Data points consist of intensities of aligned spectra peaks. The median of the four technical replicates was used as the final measurement for each peak per animal. EPS analysis was done using log-fold change between the peak intensities of treated and control samples. Peaks with a t-test p-value less than 0.01 and a fold change of at least 1.5 were included in the signatures. There were 22, 112, 207, 28, 34, 38, 8, 16 and 29 peaks in the signatures for BI-3, BYK001, Bay16, IMM125, LCB 3343, MS001, NN414, Troglitazone, and ZK226830, respectively.

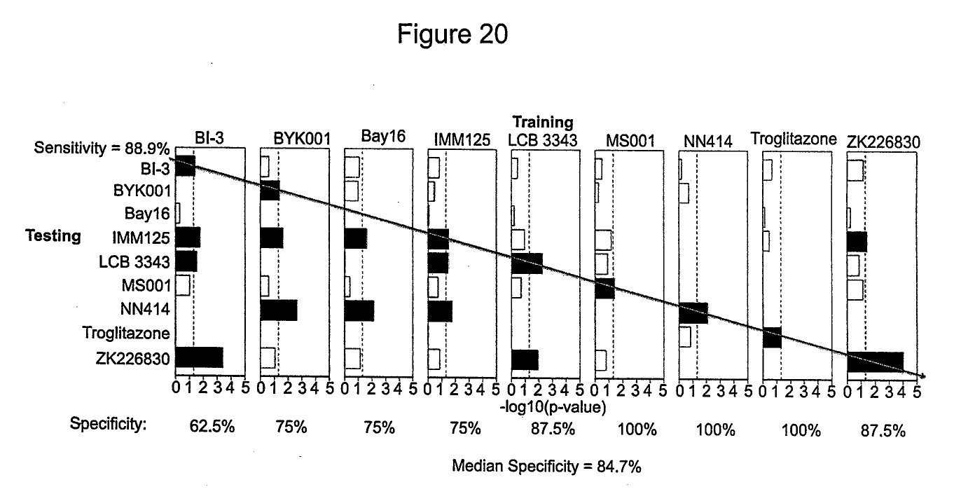

FIG. 20 demonstrates EPS' performance in predicting 3-day exposure to low doses of each of the 9 drugs using proteomics data. Each of the nine columns represents prediction results generated based on one signature. Each bar in a column represents the significance of the difference in prediction scores between treated and control samples for a particular drug, as represented by a −log 10 transformed t-test p-value. Vertical dashed lines represent a p-value cutoff of 0.05, which we took as the threshold for statistical significance. Solid bars indicate significantly elevated prediction scores (p<0.05), indicating positive detection of exposure to the signature drug.

Sensitivity of the EPS prediction was assessed as the proportion of drugs for which low-dose exposure was successfully detected by signatures generated from proteomics data for exposure to high levels of the same drugs. The assessment is graphically represented by the diagonal line in FIG. 20, which shows that 8 of the 9 drugs were successfully detected, resulting in a detection sensitivity of 89%.

Specificity of the EPS predictions was first assessed for each signature, and then averaged across all signatures. For each signature, prediction specificity was calculated as number of correctly avoided drugs (i.e., exposures that were accurately predicted as non-detected; unfilled bars) divided by the number of non-target drugs (always 8) in each column in FIG. 20. Specificities ranged from 62.5% to 100% with an average of 84.7%.

The EPS algorithm may be applied to other types of data sets besides microarray expression profiling or proteomics. This is due to the fact that the EPS algorithm requires only a matrix of continuous, quantitatively measured variables. As such, the analyte measured could be mRNA as measured by microarray chips or by high throughput RNA sequencing (RNAseq), proteins as measured by any of a number of technologies including SELDI, miRNAs as measured by qRT-PCR or arrays, or metabolites as measured by mass spectroscopy or other technologies. In each case, data from each of these different platforms would be transformed and analyzed in exactly the same way as has been described for mRNA on microarrays (above) and proteomics, in this example.

### Example 17

### Detection of Response to Therapy

A proliferation gene expression signature was generated by intersecting genes responding to serum in human fibroblasts (serum-response signature) with genes periodically expressed in synchronous Hela cells (cell cycle signature). The serum-response signature was generated using microarray data of human fibroblasts from 10 different anatomic sites (Chang et al. http://microarray-pubs.stanford.edu/wound/). Gene expression changes between 25 fibroblast samples growing in 0.1% serum and another 25 samples growing in 10% serum were compared using Cyber-T (Baldi et al.). 1882 genes differentially expressed at a false discovery rate of less than 0.005 were defined as the serum-response signature. The cell cycle signature was taken from Whitfield et al. and included 651 genes periodically expressed in synchronous Hela cells as determined by Fourier transformation, ideal profile correlation and autocorrelation. The proliferation signature used here contained the 224 genes common to the serum-response and cell cycle signatures.

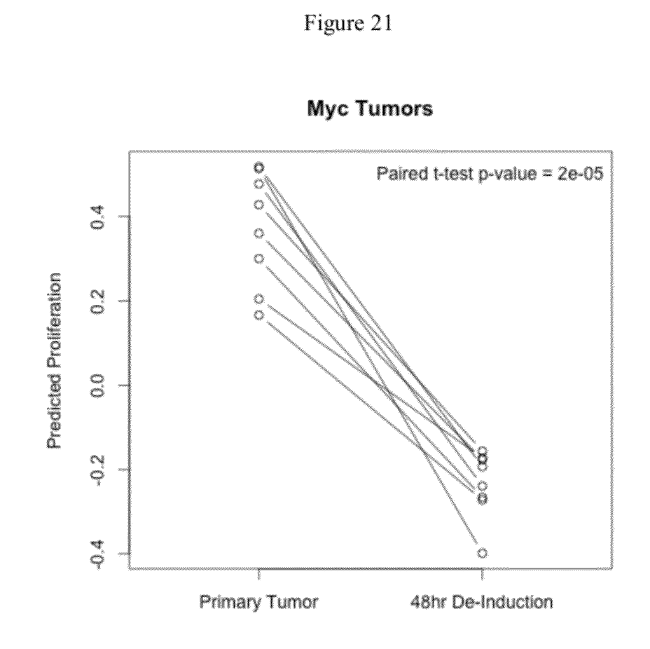

Using this proliferation signature, EPS-predicted proliferation scores were generated in paired transgenic mouse mammary tumor samples (Boxer et al.). Each pair of “untreated” and “treated” samples was derived from a Myc-driven primary tumor induced by doxycycline, and consists of one biopsy sample while the tumor was still on doxycycline (and had Myc expressed) and one sample at 48 hours after withdrawal of doxycycline (following Myc down-regulation) (FIG. 21). This is analogous to a therapy that would block the activity of the Myc oncogenic pathway, which is essentially how molecularly targeted therapies function. In this case, EPS detected a response to therapy within 48 hours (the earliest time point examined) by detecting a significant decrease in cell proliferation, which is an expected response following the blockade of an oncogenic pathway in a cancer, in this case induced by down-regulation of the Myc oncogene after doxycyline withdrawal. Overall, this finding is consistent with the medical literature in which a reduction in proliferation is observed in human cancers following treatment with a therapeutic agent that induces significant tumor shrinkage (Ma et al.).

An analogous approach may be used with other signatures that reflect other potential responses to therapy. For example, a gene expression or proteomic signature could be derived that reflects apoptosis or other forms of cell death. EPS could then be use in concert with these signatures to sensitively and specifically detect the early response to therapy.

### Example 18

### Prognosis

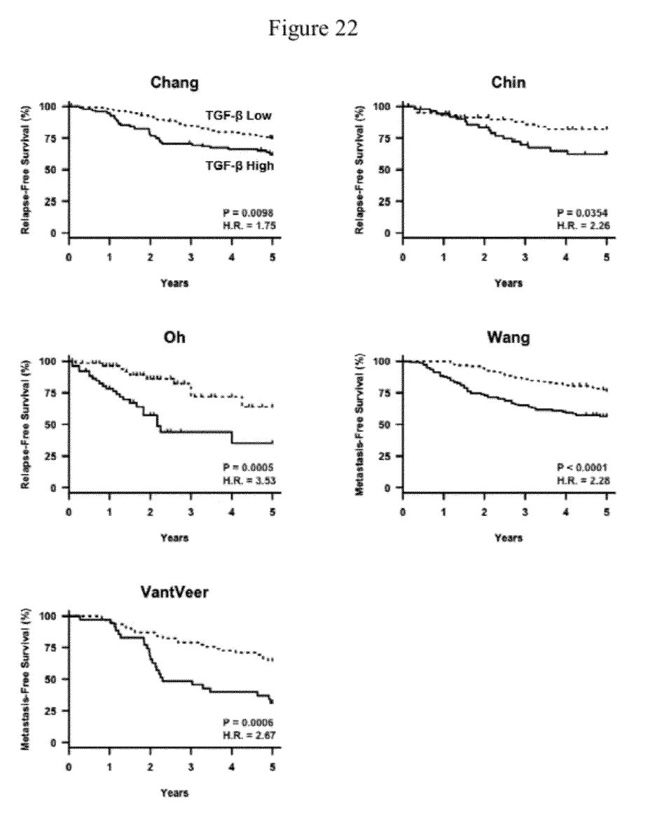

The TGF-β pathway is known to be associated with aggressive tumor behavior and poor outcome (Blobe et al., Elliot et al., and Ikushima et al.). To determine whether EPS could be used to determine prognosis, a TGFβ pathway activity signature was generated by comparing NMuMG cells treated with TGF-β1 (3 samples) or TGF-β3 (3 samples) to untreated NMuMG cells (3 samples). NMuMG cells are an untransformed mammary epithelial cell line (Liu et al.). 808 genes were differentially expressed between the 3 untreated samples and the 6 treated samples at cutoffs of t-test p-value less than 0.01 and fold change greater than 1.5, and were included in the signature. Using this signature, EPS-predicted TGFβ pathway activity was estimated in microarray data sets of human primary breast cancers (Chang et al., Chanrion et al., Chin et al., Hess et al., Miller et al., Oh et al., Pawitan et al., Sorlie et al., Van't Veer et al., and Wang et al.). Consistent with the literature cited above, significant association between predicted high TGFβ activity and poor patient outcome was observed in five data sets (FIG. 22).

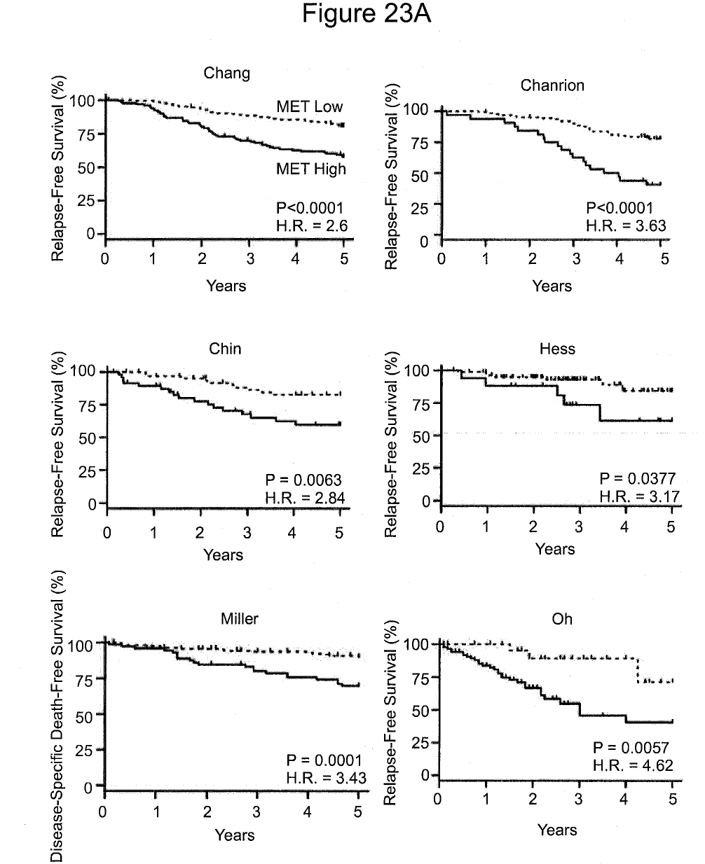

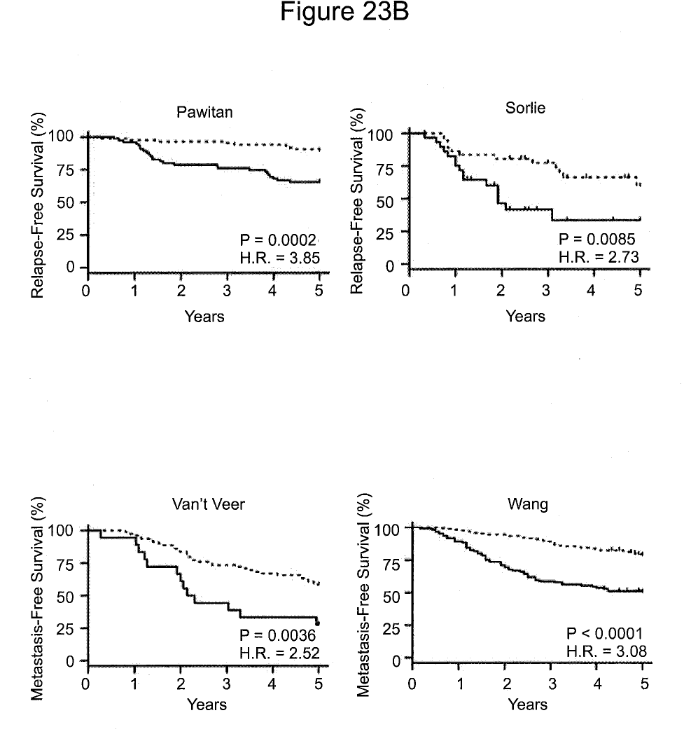

Similarly, the c-MET oncogene has also been implicated in the aggressive behavior of human breast cancers (Gastaldi et al., Eder et al., Birchmeier et al., and Peruzzi et al.). To determine whether EPS could be used to determine prognosis based on a MET signature, MET pathway activity was estimated in human breast cancer data sets (Chang et al., Chanrion et al., Chin et al., Hess et al., Miller et al., Oh et al., Pawitan et al., Sorlie et al., Van't Veer et al., and Wang et al) using a signature generated from comparing MET-Knockout hepatocytes to MET-wildtype hepatocytes treated with HGF for 24 hours (Kaposi-Novak et al, GEO data set GSE4451). 223 genes differentially expressed between MET-knockout and MET-wildtype samples at cutoffs of t-test p-value less than 0.01 and fold change greater than 1.5 were included in the signature. Consistent with the literature cited above, EPS-predicted high MET activity was associated with poor prognosis in ten human breast cancer data sets (FIG. 23).

Various terms relating to the systems, methods, and other aspects of the present invention are used throughout the specification and claims. Such terms are to be given their ordinary meaning in the art unless otherwise indicated.

The present invention is not limited to the embodiments described and exemplified above, but is capable of variation and modification within the scope and range of equivalents of the appended claims.

### REFERENCES

Benjamini Y, Hochberg Y. Controlling the false discovery rate: a practical and powerful approach to multiple testing. Journal of the Royal Statistical Society, Series B (Methodological). 1995; 57 (1): 289-300
Cappellen D, Schlange T, Bauer M, Maurer F, Hynes N E. Novel c-MYC target genes mediate differential effects on cell proliferation and migration. EMBO Rep. 2007 January; 8(1):70-6.
Majumder P K, Febbo P G, Bikoff R, Berger R, Xue Q, McMahon L M, Manola J, Brugarolas J, McDonnell T J, Golub T R, Loda M, Lane H A, Sellers W R. mTOR inhibition reverses Akt-dependent prostate intraepithelial neoplasia through regulation of apoptotic and HIF-1-dependent pathways. Nat Med. 2004 June; 10(6):594-601.
Lamb J, Crawford E D, Peck D, Modell J W, Blat I C, Wrobel M J, Lerner J, Brunet J P, Subramanian A, Ross K N, Reich M, Hieronymus H, Wei G, Armstrong S A, Haggarty S J, Clemons P A, Wei R, Carr S A, Lander E S, Golub T R. The Connectivity Map: using gene-expression signatures to connect small molecules, genes, and disease. Science. 2006 Sep. 29; 313(5795):1929-35.
Lawlor E R, Soucek L, Brown-Swigart L, Shchors K, Bialucha C U, Evan G I. Reversible kinetic analysis of Myc targets in vivo provides novel insights into Myc-mediated tumorigenesis. Cancer Res. 2006 May 1; 66(9):4591-601.
Hummel M, Bentink S, Berger H, Klapper W, Wessendorf S, Barth T F, Bernd H W, Cogliatti S B, Dierlamm J, Feller A C, Hansmann M L, Haralambieva E, Harder L, Hasenclever D, Kühn M, Lenze D, Lichter P, Martin-Subero J I, Möller P, Müller-Hermelink H K, Ott G, Parwaresch R M, Pott C, Rosenwald A, Rosolowski M, Schwaenen C, Stürzenhofecker B, Szczepanowski M, Trautmann H, Wacker H H, Spang R, Loeffler M, Trumper L, Stein H, Siebert R; Molecular Mechanisms in Malignant Lymphomas Network Project of the Deutsche Krebshilfe. A biologic definition of Burkitt's lymphoma from transcriptional and genomic profiling. N Engl J. Med. 2006 Jun. 8; 354(23):2419-30.
Godefroy N, Bouleau S, Gruel G, Renaud F, Rincheval V, Mignotte B, Tronik-Le Roux D, Vayssière J L. Transcriptional repression by p53 promotes a Bcl-2-insensitive and mitochondria-independent pathway of apoptosis. Nucleic Acids Res. 2004 Aug. 23; 32(15):4480-90.
to Miller L D, Smeds J, George J, Vega V B, Vergara L, Ploner A, Pawitan Y, Hall P, Klaar S, Liu E T, Bergh J. An expression signature for p53 status in human breast cancer predicts mutation status, transcriptional effects, and patient survival. Proc Natl Acad Sci USA. 2005 Sep. 20; 102(38):13550-5. Epub 2005 Sep. 2. Erratum in: Proc Natl Acad Sci USA. 2005 Dec. 6; 102(49):17882.
Cancer Genome Atlas Research Network. Comprehensive genomic characterization defines human glioblastoma genes and core pathways. Nature. 2008 Oct. 23; 455(7216):1061-8.
Bild A H, Yao G, Chang J T, Wang Q, Potti A, Chasse D, Joshi M B, Harpole D, Lancaster J M, Berchuck A, Olson J A Jr, Marks J R, Dressman H K, West M, Nevins J R. Oncogenic pathway signatures in human cancers as a guide to targeted therapies. Nature. 2006 Jan. 19; 439(7074):353-7.
Coldren C D, Helfrich B A, Witta S E, Sugita M, Lapadat R, Zeng C, Barón A, Franklin W A, Hirsch F R, Geraci M W, Bunn P A Jr. Baseline gene expression predicts sensitivity to gefitinib in non-small cell lung cancer cell lines. Mol Cancer Res. 2006 August; 4(8):521-8.
Ding L, Getz G, Wheeler D A, Mardis E R, McLellan M D, Cibulskis K, et al. Somatic mutations affect key pathways in lung adenocarcinoma. Nature. 2008 Oct. 23; 455(7216):1069-75.
Choi Y L, Bocanegra M, Kwon M J, Shin Y K, Nam S J, Yang J H, Kao J, Godwin A K, Pollack J R. LYN is a mediator of epithelial-mesenchymal transition and a target of dasatinib in breast cancer. Cancer Res. 2010 Mar. 15; 70(6):2296-306.
Baldi P, Long A D. A Bayesian framework for the analysis of microarray expression data: regularized t-test and statistical inferences of gene changes. Bioinformatics. 2001 June; 17(6):509-19.
Finn R S, Dering J, Conklin D, Kalous O, Cohen D J, Desai A J, Ginther C, Atefi M, Chen I, Fowst C, Los G, Slamon D J. PD 0332991, a selective cyclin D kinase 4/6 inhibitor, preferentially inhibits proliferation of luminal estrogen receptor-positive human breast cancer cell lines in vitro. Breast Cancer Res. 2009; 11(5):R77.
Prat A, Parker J S, Karginova O, Fan C et al. Phenotypic and molecular characterization of the claudin-low intrinsic subtype of breast cancer. Breast Cancer Res 2010 Sep. 2; 12(5):R68.
Herschkowitz J, Simin K, Weigman V, Mikaelian I, Usary J, Hu Z, et al. Identification of conserved gene expression features between murine mammary carcinoma models and human breast tumors. Genome Biol. 2007; 8:R76.16.
Hennessy B T, Gonzalez-Angulo A M, Stemke-Hale K, Gilcrease M Z et al. Characterization of a naturally occurring breast cancer subset enriched in epithelial-to-mesenchymal transition and stem cell characteristics. Cancer Res 2009 May 15; 69(10):4116-24.
D'Cruz C M, Gunther E J, Boxer R B, Hartman J L, Sintasath L, Moody S E, Cox J D, Ha S I, Belka G K, Golant A, Cardiff R D, Chodosh L A. c-MYC induces mammary tumorigenesis by means of a preferred pathway involving spontaneous Kras2 mutations. Nat Med. 2001 February; 7(2):235-9.
Moody S E, Sarkisian C J, Hahn K T, Gunther E J, Pickup S, Dugan K D, Innocent N, Cardiff R D, Schnall M D, Chodosh L A. Conditional activation of Neu in the mammary epithelium of transgenic mice results in reversible pulmonary metastasis. Cancer Cell. 2002 December; 2(6):451-61.
Gunther E J, Moody S E, Belka G K, Hahn K T, Innocent N, Dugan K D, Cardiff R D, Chodosh L A. Impact of p53 loss on reversal and recurrence of conditional Wnt-induced tumorigenesis. Genes Dev. 2003 Feb. 15; 17(4):488-501.
Tukey J W. Exploratory Data Analysis. Addison-Wesley. 1977
Chang H Y, Sneddon J B, Alizadeh A A, Sood R, West R B, et al. Gene Expression Signature of Fibroblast Serum Response Predicts Human Cancer Progression: Similarities between Tumors and Wounds. PLoS Biol 2004 2(2): e7
Whitfield M L, Sherlock G, Saldanha A J, Murray J I, et al. Identification of Genes Periodically Expressed in the Human Cell Cycle and Their Expression in Tumors Mol. Biol. Cell 2002 13:6
Boxer R B, Stairs D B, Dugan K D, Notarfrancesco K L, Portocarrero C P, Keister B A, Belka G K, Cho H, Rathmell J C, Thompson C B, Birnbaum M J, Chodosh L A. Isoform-specific requirement for Akt1 in the developmental regulation of cellular metabolism during lactation. Cell Metab. 2006 December; 4(6):475-90.
Sarkisian C J, Keister B A, Stairs D B, Boxer R B, Moody S E, Chodosh L A. Dose-dependent oncogene-induced senescence in vivo and its evasion during mammary tumorigenesis. Nat Cell Biol. 2007 May; 9(5):493-505.
Chin K, DeVries S, Fridlyand J, Spellman P T, Roydasgupta R, Kuo W L, Lapuk A, Neve R M, Qian Z, Ryder T, Chen F, Feiler H, Tokuyasu T, Kingsley C, Dairkee S, Meng Z, Chew K, Pinkel D, Jain A, Ljung B M, Esserman L, Albertson D G, Waldman F M, Gray J W. Genomic and transcriptional aberrations linked to breast cancer pathophysiologies. Cancer Cell. 2006 December; 10(6):529-41.
Lewis J A, Szilagyi M, Gehman E, Dennis W E, Jackson D A. Distinct patterns of gene and protein expression elicited by organophosphorus pesticides in Caenorhabditis elegans. BMC Genomics. 2009 Apr. 29; 10:202.
Suter L, Schroeder S, Meyer K, Gautier J C, Amberg A, Wendt M, Gmuender H, Mally A, Boitier E, Ellinger-Ziegelbauer H, Matheis K, Pfannkuch F. EU framework 6 project: predictive toxicology (PredTox)—overview and outcome. Toxicol Appl Pharmacol. 2011 Apr. 15; 252(2):73-84.
Ma C X, Sanchez C G, Ellis M J. Predicting endocrine therapy responsiveness in breast cancer. Oncology (Williston Park). 2009 February; 23(2):133-42.
Blobe G C, Schiemann W P, Lodish H F. Role of transforming growth factor beta in human disease. N Engl J Med. 2000 May 4; 342(18):1350-8.
Elliott R L, Blobe G C. Role of transforming growth factor Beta in human cancer. J Clin Oncol. 2005 Mar. 20; 23(9):2078-93.
Ikushima H, Miyazono K. TGFbeta signalling: a complex web in cancer progression. Nat Rev Cancer. 2010 June; 10(6):415-24.
Boxer R B, Jang J W, Sintasath L, Chodosh L A. Lack of sustained regression of c-MYC-induced mammary adenocarcinomas following brief or prolonged MYC inactivation. Cancer Cell. 2004 December; 6(6):577-86.
Liu Z, Wang M, Alvarez J V, Bonney M E, Chen C C, D'Cruz C, Pan T C, Tadesse M G, Chodosh L A. Singular value decomposition-based regression identifies activation of endogenous signaling pathways in vivo. Genome Biol. 2008; 9(12):R180.
Chang H Y, Nuyten D S, Sneddon J B, Hastie T, Tibshirani R, Sørlie T, Dai H, He Y D, van't Veer L J, Bartelink H, van de Rijn M, Brown P O, van de Vijver M J. Robustness, scalability, and integration of a wound-response gene expression signature in predicting breast cancer survival. Proc Natl Acad Sci USA. 2005 Mar. 8; 102(10):3738-43.
Chanrion M, Negre V, Fontaine H, Salvetat N, Bibeau F, Mac Grogan G, Mauriac L, Katsaros D, Molina F, Theillet C, Darbon J M. A gene expression signature that can predict the recurrence of tamoxifen-treated primary breast cancer. Clin Cancer Res. 2008 Mar. 15; 14(6):1744-52.
Chin K, DeVries S, Fridlyand J, Spellman P T, Roydasgupta R, Kuo W L, Lapuk A, Neve R M, Qian Z, Ryder T, Chen F, Feiler H, Tokuyasu T, Kingsley C, Dairkee S, Meng Z, Chew K, Pinkel D, Jain A, Ljung B M, Esserman L, Albertson D G, Waldman F M, Gray J W. Genomic and transcriptional aberrations linked to breast cancer pathophysiologies. Cancer Cell. 2006 December; 10(6):529-41.
Hess K R, Anderson K, Symmans W F, Valero V, Ibrahim N, Mejia J A, Booser D, Theriault R L, Buzdar A U, Dempsey P J, Rouzier R, Sneige N, Ross J S, Vidaurre T, Gómez H L, Hortobagyi G N, Pusztai L. Pharmacogenomic predictor of sensitivity to preoperative chemotherapy with paclitaxel and fluorouracil, doxorubicin, and cyclophosphamide in breast cancer. J Clin Oncol. 2006 Sep. 10; 24(26):4236-44.
Oh D S, Troester M A, Usary J, Hu Z, He X, Fan C, Wu J, Carey L A, Perou C M. Estrogen-regulated genes predict survival in hormone receptor-positive breast cancers. J Clin Oncol. 2006 Apr. 10; 24(11):1656-64.
Pawitan Y, Bjöhle J, Amler L, Borg A L, Egyhazi S, Hall P, Han X, Holmberg L, Huang F, Klaar S, Liu E T, Miller L, Nordgren H, Ploner A, Sandelin K, Shaw P M, Smeds J, Skoog L, Wedrén S, Bergh J. Gene expression profiling spares early breast cancer patients from adjuvant therapy: derived and validated in two population-based cohorts. Breast Cancer Res. 2005; 7(6):R953-64.
Sørlie T, Perou C M, Tibshirani R, Aas T, Geisler S, Johnsen H, Hastie T, Eisen M B, van de Rijn M, Jeffrey S S, Thorsen T, Quist H, Matese J C, Brown P O, Botstein D, Eystein Lønning P, Børresen-Dale A L. Gene expression patterns of breast carcinomas distinguish tumor subclasses with clinical implications. Proc Natl Acad Sci USA. 2001 Sep. 11; 98(19):10869-74.
van't Veer L J, Dai H, van de Vijver M J, He Y D, Hart A A, Mao M, Peterse H L, van der Kooy K, Marton M J, Witteveen A T, Schreiber G J, Kerkhoven R M, Roberts C, Linsley P S, Bernards R, Friend S H. Gene expression profiling predicts clinical outcome of breast cancer. Nature. 2002 Jan. 31; 415(6871):530-6.
Wang Y, Klijn J G, Zhang Y, Sieuwerts A M, Look M P, Yang F, Talantov D, Timmermans M, Meijer-van Gelder M E, Yu J, Jatkoe T, Berns E M, Atkins D, Foekens J A. Gene-expression profiles to predict distant metastasis of lymph-node-negative primary breast cancer. Lancet. 2005 Feb. 19-25; 365(9460):671-9.
Gastaldi S, Comoglio P M, Trusolino L. The Met oncogene and basal-like breast cancer: another culprit to watch out for? Breast Cancer Res. 2010; 12(4):208.
Eder J P, Vande Woude G F, Boerner S A, LoRusso P M. Novel therapeutic inhibitors of the c-Met signaling pathway in cancer. Clin Cancer Res. 2009 Apr. 1; 15(7):2207-14.
Birchmeier C, Birchmeier W, Gherardi E, Vande Woude G F. Met, metastasis, motility and more. Nat Rev Mol Cell Biol 2003; 4:915-25.
Peruzzi B, Bottaro D P. Targeting the c-Met signaling pathway in cancer. Clin Cancer Res 2006; 12:3657-60.
Kaposi-Novak P, Lee J S, Gòmez-Quiroz L, Coulouarn C, Factor V M, Thorgeirsson S S. Met-regulated expression signature defines a subset of human hepatocellular carcinomas with poor prognosis and aggressive phenotype. J Clin Invest. 2006 June; 116(6): 1582-95.
Moody S E, Perez D, Pan T C, Sarkisian C J, Portocarrero C, Sterner C J, Notorfrancesco K, Cardiff R D, and Chodosh L A. The transcriptional repressor, Snail, promotes mammary tumor recurrence. Cancer Cell 8:197-209, 2005.

What is claimed:

1. A method for quantitatively assessing the status of a biological event in a testing sample, comprising:
(a) computing, on at least one processor, a relative testing analyte level for each of a plurality of signature analytes in the testing sample by comparing an analyte level for the each of the signature analytes in the testing sample with a corresponding analyte level in one or more testing set control samples, wherein the each of the signature analytes exhibits a change in the analyte level when the status of the biological event is altered, and wherein the biological event in the one or more testing set control samples exhibits an activity;
(b) computing, on at least one processor, a pair-wise energy score for each of analyte pairs of the plurality of the signature analytes in the testing sample based on a testing magnitude value and a relative correlation value for the each of the analyte pairs in the testing sample, by:
(i) computing the testing magnitude value for the each of the analyte pairs based on the relative testing analyte levels for the signature analytes in the each of the analyte pairs in the testing sample,
(ii) computing a testing correlation value for the each of the analyte pairs based on a correlation between the relative testing analyte levels for the signature analytes in the each of the analyte pairs in the testing sample, and
(iii) computing the relative correlation value for the each of the analyte pairs by comparing the testing correlation value for the each of the analyte pairs in the testing sample with a reference correlation value for the each of the analyte pairs; and
(c) computing, on at least one processor, an energy-paired score for the biological event in the testing sample by combining the pair-wise energy score for the each of the analyte pairs in the testing sample.

2. The method of claim 1, further comprising computing a significance level of the energy-paired score.

3. The method of claim 1, further comprising obtaining testing analyte profiles, wherein the testing analyte profiles comprise the analyte level for the each of the signature analytes in the testing sample and the corresponding analyte level in the one or more testing set control samples.

4. The method of claim 1, further comprising:
(a) obtaining reference analyte profiles, wherein the reference analyte profiles comprise an analyte level for the each of the signature analytes in one or more training set reference samples and a corresponding analyte level in the one or more training set control samples, wherein the status of the biological event in the one or more training set reference samples is altered relative to a corresponding status of the biological event in the one or more training set control samples;
(b) computing a relative reference analyte level for each of the signature analytes by comparing the analyte level for the each of the signature analytes in the one or more training set reference samples with the corresponding analyte level in the one or more training set control samples; and
(c) computing the reference correlation value for the each of the analyte pairs based on a correlation between the relative reference expression levels for the signature genes in the each of the gene pairs in the one or more training set reference samples.

5. The method of claim 1, further comprising selecting the plurality of the signature analytes in the testing sample.

6. The method of claim 5, wherein selecting the plurality of the signature analytes comprises selecting 50-500 signature analytes.

7. The method of claim 1, further comprising identifying the analyte pairs of the signature analytes in the testing sample.

8. The method of claim 1, wherein the testing sample is a biological sample comprising a cell, a tissue, a bodily fluid, an organism, or a combination thereof.

9. The method of claim 1, wherein the biological event is a biological action or response.

10. The method of claim 9, wherein the biological action is selected from the group consisting of signal pathways, cell states, disease states, proliferation, and apoptosis.

11. The method of claim 10, wherein the biological response is a response to a biological molecule, a chemical compound, a physical agent, a therapy, or a combination thereof.

12. The method of claim 11, wherein the chemical compound is a toxin.

13. The method of claim 1, wherein the analyte is a biological molecule or chemical compound.

14. The method of claim 1, wherein the analyte is selected from the group consisting of an mRNA, a protein, a non-coding RNA, a metabolite, or a derivative thereof.

15. The method of claim 2, further comprising treating the testing sample with an agent in an effective amount for down-regulating the biological event in the testing sample, wherein a significant positive energy-paired score is computed for the biological event in the testing sample, and wherein the agent is capable of down-regulating the biological event.

16. The method of claim 2, further comprising treating the testing sample with an agent in an effective amount for up-regulating the biological event in the testing sample, wherein a significant negative energy-paired score is computed for the biological event in the testing sample, and wherein the agent is capable of up-regulating the biological event.

17. A system for quantitatively assessing the status of a biological event in a testing sample, comprising at least one processor, and a computer readable medium coupled to the at least one processor, having instructions which when executed cause the at least one processor to:
(a) compute a relative testing analyte level for each of a plurality of signature analytes in the testing sample by comparing an analyte level for the each of the signature analytes in the testing sample with a corresponding analyte level in one or more testing set control samples, wherein the each of the signature analytes exhibits a change in the analyte level when the status of the biological event is altered, and wherein the biological event in the one or more testing set control samples exhibits an activity;
(b) compute a pair-wise energy score for each of analyte pairs of the plurality of the signature analytes in the testing sample based on a testing magnitude value and a relative correlation value for the each of the analyte pairs in the testing sample, by:
(i) computing the testing magnitude value for the each of the analyte pairs based on the relative testing analyte levels for the signature analytes in the each of the analyte pairs in the testing sample,
(ii) computing a testing correlation value for the each of the analyte pairs based on a correlation between the relative testing analyte levels for the signature analytes in the each of the analyte pairs in the testing sample, and
(iii) computing the relative correlation value for the each of the analyte pairs by comparing the testing correlation value for the each of the analyte pairs in the testing sample with a reference correlation value for the each of the analyte pairs; and
(c) compute an energy-paired score for the biological event in the testing sample by combining the pair-wise energy score for the each of the analyte pairs in the testing sample.

18. The system of claim 17, wherein said computer readable medium has further instructions which when executed cause the at least one processor to compute a significance level of the energy-paired score.

19. A signal processing system for quantitatively assessing the status of a biological event in a testing sample, comprising:
(a) a relative testing analyte processor having an input and an output, wherein the relative testing analyte processor is configured to compute a relative testing analyte level for each of a plurality of signature analytes in the testing sample by comparing an analyte level for the each of the signature analytes in the testing sample with a corresponding analyte level in one or more testing set control samples, wherein the each of the signature analytes exhibits a change in analyte level when the status of the biological event is altered, and wherein the biological event in the one or more testing set control samples exhibits an activity;
(b) a testing magnitude processor having an input and an output, wherein the input of the testing magnitude processor is connected with the output of the relative testing analyte processor, and the testing magnitude processor is configured to compute a testing magnitude value for each of analyte pairs of the plurality of the signature analytes in the testing sample based on the relative testing analyte levels for the signature analytes in the each of the analyte pairs in the testing sample;
(c) a testing correlation processor having an input and an output, wherein the input of the testing correlation processor is connected with the output of the relative testing analyte processor, and the testing correlation processor is configured to compute a testing correlation value for each of the analyte pairs in the testing sample based on a correlation between the relative testing analyte levels for the signature analytes in the each of the analyte pairs in the testing sample;
(d) a relative correlation processor having an input and an output, wherein the input of the relative correlation processor is connected with the output of the testing correlation processor, and the relative correlation processor is configured to compute a relative correlation value for the each of the analyte pairs in the testing sample by comparing the testing correlation value for the each of the analyte pairs in the testing sample with a reference correlation value for the each of the analyte pairs;
(e) a pair-wise energy processor having an input and an output, wherein the input of the pair-wise energy processor is connected with the output of the testing magnitude processor and the output of the relative correlation processor, and the pair-wise energy processor is configured to compute a pair-wise energy score for the each of the analyte pairs in the testing sample based on the testing magnitude value and the relative correlation value for the each of the analyte pairs in the testing sample; and
(f) an energy-paired score processor having an input and an output, wherein the input of the pair-wise energy processor is connected with the output of the pair-wise energy processor, and the energy-paired score processor is configured to compute an energy-paired score for the biological event in the testing sample by combining the pair-wise energy score for the each of the analyte pairs in the testing sample.

20. The signal processing system of claim 19, further comprising an energy significance processor having an input and an output, wherein the input of the energy significance processor is connected with the output of the energy-paired score processor, and the energy significance processor is configured to compute a significance level of the energy-paired score.
